(19) United States
(12) Patent Application Publication
(10) Pub. No.: US 2025/0119954 A1
(43) Pub. Date: Apr. 10, 2025

(54) RANDOM-ACCESS CHANNEL PROCEDURE USING NEURAL NETWORKS

(71) Applicant: GOOGLE LLC, Mountain View, CA (US)

(72) Inventors: Jibing Wang, San Jose, CA (US); Erik Richard Stauffer, Sunnyvale, CA (US)

(21) Appl. No.: 18/836,294

(22) PCT Filed: Feb. 6, 2023
(86) PCT No.: PCT/US2023/012413

§ 371 Date: Aug. 6, 2024

Related U.S. Application Data
(60) Provisional application No. 63/307,407, filed on Feb. 7, 2022.

(51) Int. Cl. H04W 74/0833; G06N 3/045; G06N 3/096

(52) U.S. Cl. CPC H04W 74/0833; G06N 3/045; G06N 3/096

(57) ABSTRACT

A wireless communication system employs DNNs or other neural networks to provide for RACH techniques. A TX DNN at user equipment (UE) generates and provides for wireless transmission of a Random Access (RA) signal to a base station (BS). A BS receives the RA signal as input, and from this input generates and provides for wireless transmission of an RA Response signal to the UE.

### BACKGROUND

Wireless communication systems often implement a Random-Access Channel (RACH) procedure used by cellular devices, such as mobile phones, wearable electronic devices, and other user equipment (UE), during various events. For example, a UE can perform a RACH procedure during initial network access, handover, or uplink (UL) data transmission. The RACH procedure enables the UE to acquire uplink (UL) synchronization and UL transmission resources. A UE can perform Contention-free Random Access (CFRA) or contention-based Random Access (CBRA) using a four-step or two-step RACH procedure as defined by Third Generation Partnership Project (3GPP) Release 15 and 3GPP Release 16, respectively.

### SUMMARY OF EMBODIMENTS

In accordance with some embodiments, a computer-implemented method, in a user equipment (UE) device of a cellular communication system, includes: receiving Random Access (RA) configuration information at the UE; configuring a transmit neural network based on the RA configuration information; generating, by the transmit neural network, a first output, the first output representing a first RA signal for an RA procedure between the UE and a base station (BS) of the cellular communication system; and controlling a radio frequency (RF) antenna interface of the UE to transmit a first RF signal representative of the first output for receipt by the BS.

In accordance with some embodiments, a computer-implemented method, in a base station (BS) of a cellular communication system, includes: generating, by a transmit neural network of the BS, a first output representing a Random Access (RA) Response signal including an RA Response for an RA procedure between the BS and a user equipment (UE) of the cellular communication system; and controlling a radio frequency (RF) antenna interface of the BS to transmit a first RF signal representative of the RA Response signal for receipt by the UE.

In various embodiments, this method further can include one or more of the following aspects. Receiving, at the RF antenna interface prior to generating the first output, a second RF signal from the UE, the second RF signal representative of an RA signal for the RA procedure, wherein the first output is generated based on the second RF signal received from the UE. The method can also include providing a representation of the second RF signal as a first input to a receive neural network of the BS; generating, by the receive neural network, a second output based on the first input to the receive neural network; generating RA Response information based on the second output; and providing the RA Response information as a second input to the transmit neural network of the first device, wherein the transmit neural network generates the RA Response signal based on the second input. The RA signal is associated with an RA preamble. The RA Response includes at least an uplink resource allocation for the UE. The method can further include generating Contention Resolution information based on the second output; and providing the Contention Resolution information as a third input to the transmit neural network of the BS, wherein the transmit neural network generates the RA Response signal based on the third input. The method can also include, responsive to transmitting the first RF signal, receiving, at the RF antenna, a second RF signal from the UE, the second RF signal representative of an uplink transmission; responsive to receiving the second RF signal, generating a second output representing a Contention Resolution message; providing the second output as an input to the transmit neural network; generating, by the transmit neural network, a third output based on the input to the transmit neural network, the third output representing a Contention Resolution signal including the Contention Resolution message; and controlling the RF antenna interface of the BS to transmit a third RF signal representative of the Contention Resolution signal for receipt by the UE. Generating the second output representing the Contention Resolution message includes: providing a representation of the second RF signal as an input to a receive neural network of the BS; and generating, by the receive neural network, the second output representing the Contention Resolution message based on the input to the receive neural network. Generating the first output representing the RA Response includes determining that the RA signal includes a Contention Resolution identifier associated with the UE, and wherein generating the first output includes including the Contention Resolution identifier in the first output.

In accordance with some embodiments, a computer-implemented method, in a user equipment (UE) device of a cellular communication system, includes: receiving capability information from at least one of a first device or a second device in a cellular communication system; selecting a first neural network architectural configuration from a set of candidate neural network architectural configurations based on the capability information, the first neural network architectural configuration being trained to implement a Random Access procedure between the first device and the second device; and transmitting to the first device a first indication of the first neural network architectural configuration for implementation at one or more of a transmit neural network and a receive neural network of the first device.

In some embodiments, a device includes a radio frequency (RF) antenna interface; at least one processor coupled to the RF antenna interface; and a memory storing executable instructions, the executable instructions configured to manipulate the at least one processor to perform any of the methods described above and herein.

### BRIEF DESCRIPTION OF THE DRAWINGS

The present disclosure is better understood and its numerous features and advantages are made apparent to those skilled in the art by referencing the accompanying drawings. The use of the same reference symbols in different drawings indicates similar or identical items.

FIG. 1 is a diagram illustrating an example wireless system employing a neural network architecture for performing one or more RACH procedures in accordance with some embodiments.

FIG. 2 is a diagram illustrating example hardware configuration of a UE of the wireless system of FIG. 1 in accordance with some embodiments.

FIG. 3 is a diagram illustrating example hardware configuration of a BS of the wireless system of FIG. 1 in accordance with some embodiments.

FIG. 4 is a diagram illustrating an example hardware configuration of a managing infrastructure component of the wireless system of FIG. 1 in accordance with some embodiments.

FIG. 5 is a diagram illustrating a machine learning (ML) module employing a neural network for use in a RACH neural network architecture in accordance with some embodiments.

FIG. 6 is a diagram illustrating a pair of jointly-trained neural networks for the processing and transmission of RA-based signals between a UE and a BS in accordance with some embodiments.

FIG. 7 is a flow diagram illustrating an example method for joint training of a set of neural networks for facilitating one or more RA procedures in a wireless system in accordance with some embodiments.

FIG. 8 to FIG. 12 are diagrams together illustrating an example method for performing one or more RACH procedures using a selected and individually or jointly trained set of neural networks in accordance with some embodiments.

FIG. 13 is a ladder signaling diagram illustrating example operations of the method of FIG. 8 and FIG. 9 in accordance with some embodiments.

FIG. 14 is a ladder signaling diagram illustrating example operations of the method of FIG. 9 and FIG. 10 in accordance with some embodiments.

FIG. 15 is a ladder signaling diagram illustrating example operations of the method of FIG. 11 and FIG. 12 in accordance with some embodiments.

FIG. 16 is a ladder signaling diagram for conventional CFRA.

FIG. 17 is a ladder signaling diagram for conventional four-step CBRA.

FIG. 18 is a ladder signaling diagram for conventional two-step CBRA.

### DETAILED DESCRIPTION

Wireless communication systems typically implement one or more different RACH procedures, such as CFRA, four-step CBRA, or two-step CFRA/CBRA. Designing and implementing these different RACH procedures can be a detailed and challenging task. For example, in a conventional wireless communication system, each different RACH procedure typically relies on a series of processing stages/blocks, such as RACH signal transmission and processing, RAR signal transmission and processing, Physical Uplink Shared Channel (PUSCH) signal transmission and processing, and CR signal transmission and processing. Furthermore, the design, testing, and implementation of these processing stages are relatively separate from each other. This custom and independent design approach for each process stage results in excessive complexity, resource consumption, and overhead. However, as described below, a wireless communication system trains and implements one or more deep neural networks (DNNs) capable of accommodating different RACH procedures with less engineering resources than conventional hardware development. The DNNs also reduce false or erroneous detection of RACH signals, congestion, and interference typically experienced by conventional RACH implementations, thereby mitigating RACH throughput degradation and connection failures with UEs.

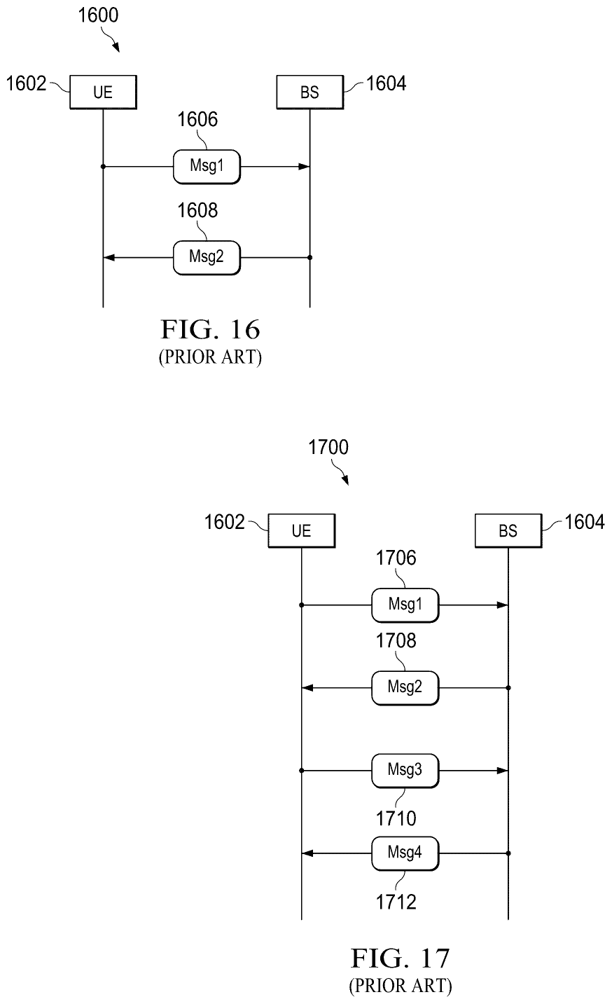

The ladder signaling diagram 1600 of FIG. 16 illustrates one example of conventional CFRA. The UE 1602 transmits a preamble message 1606 to the BS 1604. For example, the UE 1602 transmits the preamble message 1606 on a Physical Random Access Channel (PRACH) as a first message (Msg1) of the RACH procedure. In response to successfully receiving the Msg1 1606, the BS 1604 generates and transmits a Random Access Response (RAR) message 1608 to the UE 1602 as a second message (Msg2) of the RACH procedure. If the UE 1602 successfully receives the Msg2 1608, the UE 1602 can decode RAR information on a Physical Downlink Shared Channel (PDSCH) associated with the Msg2 1608. Based on decoding the RAR information, the UE 1602 obtains, for example, a Resource Block (RB) assignment and a Modulation and Coding Scheme (MCS) configuration as transmitted by the BS 1604. If the UE 1602 does not successfully receive the Msg2 1608 during the RAR window, the UE 1602 retransmits the preamble message 1606 up to a threshold number of times. The CFRA procedure concludes upon the UE 1602 successfully receiving the Msg2 1608.

The ladder signaling diagram 1700 of FIG. 17 illustrates one example of conventional four-step CBRA. Conventional four-step CBRA typically operates similarly to conventional CFRA. However, in conventional four-step CBRA, the UE 1602 randomly selects a RACH preamble from a pool of preambles shared with other UEs. Therefore, the UE 1602 might select the same preamble as another UE and potentially experience conflict or contention when it transmits either a Msg1 1706 or a UL transmission (called a Msg3) 1710 on a PUSCH. For example, multiple UEs can attempt RA with the same RA preamble sequence on the same RA channel. As such, the BS 1604 implements a contention resolution mechanism to manage these CBRA-based access requests. In FIG. 17, the processes implemented by the UE 1602 for transmitting the Msg1 1706 and the processes implemented by the BS 1604 for transmitting the Msg2 1708 are the same (or similar) to the processes 1606, 1608 for CFRA described with respect to the FIG. 16. FIG. 17 further shows that, in response to successfully receiving the Msg2 1708, the UE 1602 transmits a UL transmission 1710 (Msg3) to the BS 1604.

The BS 1604 receives the Msg3 1710 from the UE 1602. However, in some instances, the BS 1604 also receives a Msg3 from other UEs on the same assignment in response to these UEs also having received the Msg2 from the BS 1604. Therefore, the BS 1604 transmits a Contention Resolution (CR) message 1712 to the UE 1602 as a fourth message (Msg4) of the RACH procedure. If the UE 1602 receives a Msg4 1712 associated with the UE 1602 before a contention resolution timer expires, the UE 1602 considers contention resolution successful and enters into a Radio Resource Control (RRC) CONNECTED state. Otherwise, the UE 1602 retries the RACH procedure.

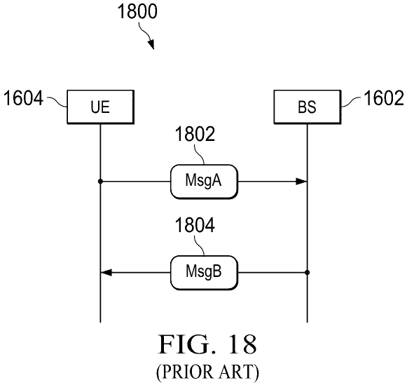

The ladder signaling diagram 1800 of FIG. 18 illustrates one example of conventional two-step CFRA/CBRA. In this example, the UE 1602 receives an indication of a dedicated RACH preamble from the BS 1604 or randomly selects the RACH preamble based on access parameters obtained from the BS 1604. In another example, the access parameters also indicate a PUSCH assignment from the BS 1604. In two-step CFRA/CBRA, the UE 1602 transmits a single message 1802 (MsgA) based on the RACH preamble and PUSCH assignment that represents the Msg1 (preamble message) 1606 and the Msg3 (UL PUSCH transmission) 1710 together. The BS 1604 receives the MsgA 1802 from the UE 1602 and transmits a single message 1804 (MsgB) that represents both a Msg2 (RAR message) 1608 and a Msg4 (CR message) 1704. The UE 1602 monitors for the MsgB 1804 within a configured window. For CFRA (dedicated preamble), the UE 1602 ends the RACH procedure in response to successfully receiving the MsgB 1804 from the BS 1604. For CBRA (randomly selected preamble), the UE 1602 ends the RACH procedure in response to successfully receiving the MsgB 1804 and performing contention resolution. If the UE 1602 cannot successfully complete the RACH procedure after a threshold number of MsgA transmissions, the UE 1602 falls back to the conventional four-step CBRA procedure.

Rather than take a handcrafted approach for each process stage of RACH procedures, the following describes example systems and techniques that utilize an end-to-end neural network configuration for RACH procedures. This end-to-end neural network configuration provides for rapid development and deployment in addition to optimized RACH procedures that are less prone to erroneous detection of RACH signals, congestion, and interference relative to conventional RACH implementations. Conventional processing stages for RACH procedures, such as those described above with respect to FIG. 16 to FIG. 18, are replaced by or supplemented by one or more individually trained or one or more pairs of jointly trained neural networks that operate to perform a RACH procedure(s). The individually or jointly trained neural network architecture includes a set of neural networks, each of which is trained to, in effect, provide more accurate and efficient RACH operations than conventional sequences of RACH stages without having to be specifically designed and tested for that sequence of RACH stages. The individually or jointly trained neural network architecture can implement one or more RACH processes, such as RACH (PRACH) signal transmission and processing, RAR signal transmission and processing, PUSCH signal transmission and processing, and CR signal transmission and processing.

In at least some embodiments, the wireless system can employ joint training of multiple candidate neural network architectural configurations for the various neural networks employed among the UEs and BSs based on any of a variety of parameters, such as the operating characteristics of (e.g., frequency, bandwidth, etc.) of a BS, UE reported reference signal received power (RSRP), Doppler estimate, deployment information, compute resources, sensor resources, power resources, antenna resources, other capabilities, and the like. Thus, in at least some embodiments, the particular neural network configuration employed at each of UE and BS is selected based on correlations between the particular configuration of these devices and the parameters used to train corresponding neural network architectural configurations.

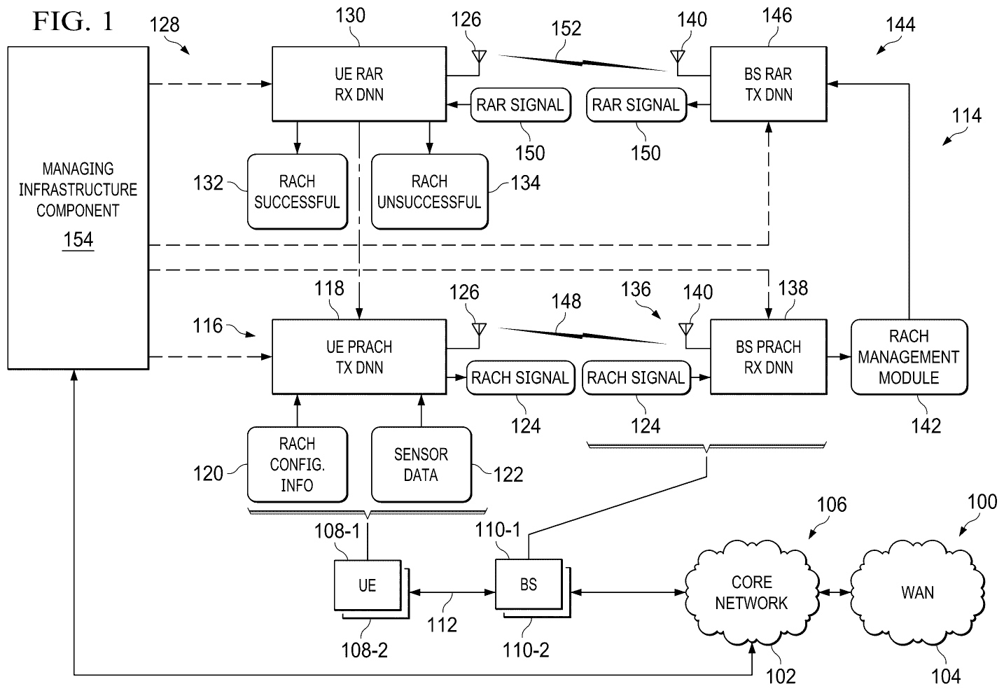

FIG. 1 illustrates a wireless communications system 100 employing neural-network-facilitated Random Access (RACH procedure) in accordance with some embodiments. As depicted, the wireless communication system 100 is a cellular network that is coupled to a network infrastructure 106 including, for example, a core network 102, one or more wide area networks (WANs) 104 or other packet data networks (PDNs), such as the Internet, a combination thereof, or the like. The wireless communications system 100 further includes one or more UEs 108 (illustrated as UEs 108-1 and 108-2) and one or more BSs 110 (illustrated as BSs 110-1 and 110-2). Each BS 110 supports wireless communication UEs 108 through one or more wireless communication links 112, which can be unidirectional or bi-directional. In at least some embodiments, each BS 110 is configured to communicate with the UE 108 through the wireless communication links 112 via radio frequency (RF) signaling using one or more applicable RATs as specified by one or more communications protocols or standards. As such, each BS 110 operates as a wireless interface between the UE 108 and various networks and services provided by the core network 102 and other networks, such as packet-switched (PS) data services, circuit-switched (CS) services, and the like. Conventionally, communication of data or signaling from a BS 110 to the UE 108 is referred to as “downlink” or “DL”, whereas communication of data or signaling from the UE 108 to a BS 110 is referred to as “uplink” or “UL”. In at least some embodiments, a BS 110 also includes an inter-base station interface, such as an Xn and/or X2 interface, configured to exchange user-plane and control-plane data between another BS 110.

Each BS 110 can employ any of a variety or combination of RATs, such as operating as a NodeB (or base transceiver station (BTS)) for a Universal Mobile Telecommunications System (UMTS) RAT (also known as “3G”), operating as an enhanced NodeB (eNodeB) for a 3GPP Long Term Evolution (LTE) RAT, operating as a 5G node B (“gNB”) for a 3GPP Fifth Generation (5G) New Radio (NR) RAT, and the like. Each BS 110 can be an integrated base station or can be a distributed base station with a Central Unit (CU) and one or more Distributed Units (DU). The UE 108, in turn, can implement any of a variety of electronic devices operable to communicate with the BS 110 via a suitable RAT, including, for example, a mobile cellular phone, a cellular-enabled tablet computer or laptop computer, a desktop computer, a cellular-enabled video game system, a server, a cellular-enabled appliance, a cellular-enabled automotive communications system, a cellular-enabled smartwatch or other wearable device, and the like.

The UE 108 obtains synchronization and resources for communicating with the BS 110 by performing a RACH procedure. As described above, RACH procedures in a conventional wireless communication system typically rely on a series of processing stages/blocks that result in excessive complexity, resource consumption, and overhead. Accordingly, in at least some embodiments, the UE 108 and the BS 110 each implement transmitter (TX) and receiver (RX) processing paths that integrate one or more neural networks (NNs) that are trained or otherwise configured to facilitate RACH techniques.

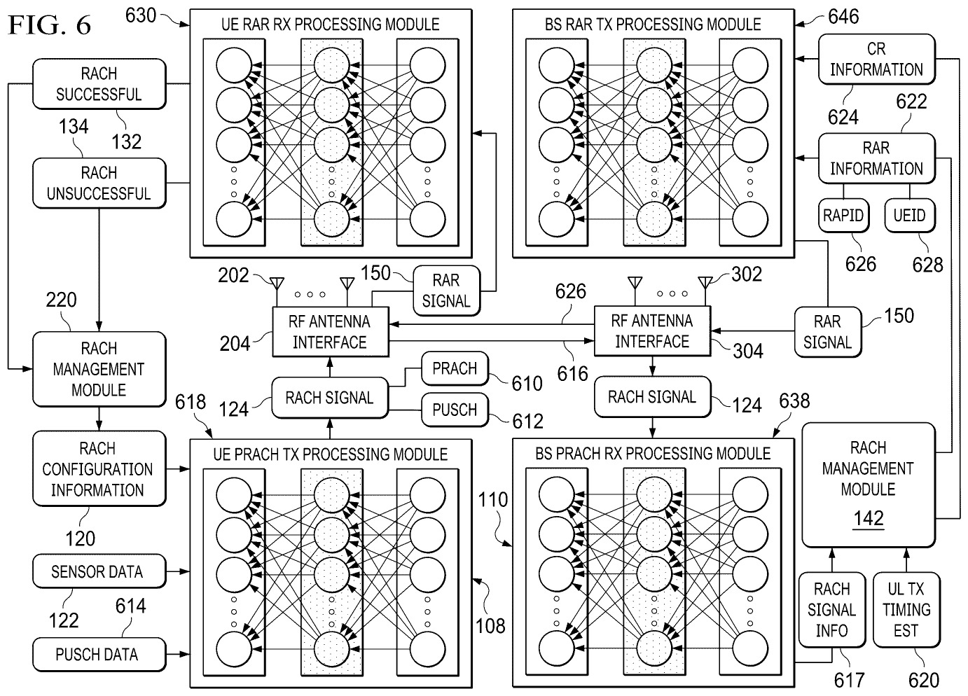

To illustrate, with respect to a RACH path 114 established between one or more UEs 108 and BSs 110, the UE 108 employs a TX processing path 116 having a UE PRACH TX DNN 118 or another neural network. The UE PRACH TX DNN 118 has an input configured to receive RACH configuration information 120 and other information, such as sensor data 122, for generating a RACH signal 124, which is described below in more detail with respect to FIG. 6. The UE PRACH TX DNN 118 further includes an output coupled to an RF front end 126 of the UE 108.

In at least some embodiments, the UE 108 also employs an RX processing path 128 having a UE RAR RX DNN 130 or another neural network. The UE RAR RX DNN 130 has an input coupled to the RF front end 126 and an output configured to generate, for example, an indication 132 that the RACH procedure was successful or an indication 134 that the RACH procedure was unsuccessful.

The BS 110, in at least some embodiments, employs an RX processing path 136 having a BS PRACH RX DNN 138 or another neural network. The BS PRACH RX DNN 138 has an input coupled to an RF front end 140. The input of the BS PRACH RX DNN 138 is configured to receive, for example, DNN-created RACH signals 124, conventionally created RACH signals, or a combination thereof transmitted by UEs 108, as described below with respect to FIG. 6. The BS PRACH RX DNN 138, in at least some embodiments, has an output coupled to a RACH management module 142 of the BS 110.

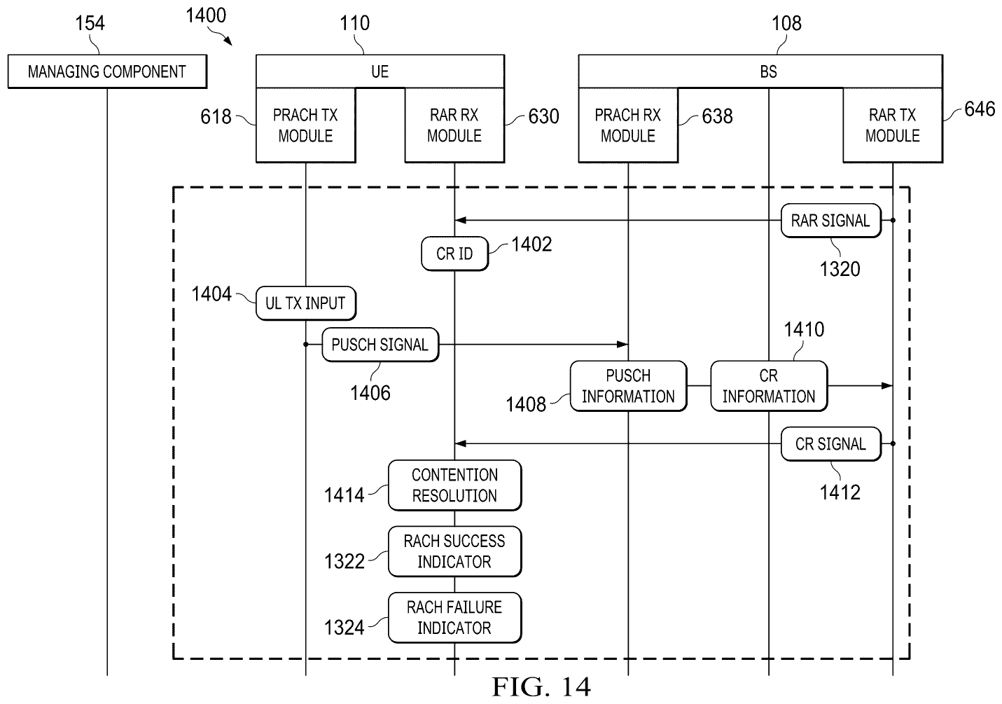

The BS 110 further employs a TX processing path 144 having a BS RAR TX DNN 146 or another neural network. The BS RAR TX DNN 146, in at least some embodiments, has an input coupled to the output of the BS RACH management module 142. In other embodiments, the input of the BS RAR TX DNN 146 is coupled to the output of the BS PRACH RX DNN 138. The BS RAR TX DNN 146 further has an output coupled to the RF front end 140 and generates an output representing an RAR signal 150, a CR signal 1412 (FIG. 14), or a combination thereof.

In at least some embodiments, the BS 110 (or another cellular network component) configures or indicates a configuration for at least one of the UE PRACH TX DNN 118, UE RAR RX DNN 130, BS PRACH RX DNN 138, or RAR TX DNN 146 based on one or more of the cell size of the BS 110, the selection of RACH DNNs (e.g., PRACH RX DNNs and RAR TX DNNs) of other cells, operating characteristics of the UE 108, operating characteristics of the BS 110, UE reported reference signal received power (RSRP), a speed estimate of the UE, a Doppler estimate of the UE, deployment information, and the like. For example, different BSs 110 can coordinate with each other regarding the set of RACH DNNs to be configured for neighboring cells and their UEs 108 such that different neighboring cells use a different set of RACH DNNs (e.g., different architectures/weights). Different neighboring cells can use the same time/frequency resources for RACH. However, the RACH DNNs of neighboring cells generate different RACH sequences to reduce the possibility of a first BS 110-1 detecting a RACH from a UE 108 attempting to connect with a second BS 110-2. The UE 108, in at least some embodiments, receives the particular neural network architecture, or at least an indication thereof, from the BS 110 (or another network component) via one or more control messages, such as an RRC message.

In operation, one or more of the UE PRACH TX DNN 118, UE RAR RX DNN 130, BS PRACH RX DNN 138, RAR TX DNN 146 are trained, jointly trained, or otherwise configured together to perform one or more RACH operations. The UE PRACH TX DNN 118 is configured to receive RACH configuration information 120, PUSCH data 614 (FIG. 6), and the like as input. In some embodiments, other inputs, such as sensor data 122 (or information generated based on sensor data 122) from sensors of the UE 108, are concurrently provided as inputs to the UE PRACH TX DNN 118. Examples of sensor data 122 input (or associated information) include UE speed estimates, UE Doppler estimates, Global Positioning System (GPS) data, camera data, accelerometer data, internal measurement unit (IMU) data, altimeter data, temperature data, barometer data, object detection sensors (e.g., radar sensors, lidar sensors. imaging sensors, or structured-light-based depth sensors), and the like.

The UE can receive RACH configuration information 120 from, for example, the BS 110 System Information Block (SIB) messages or RRC messages depending on how the UE 108 is trying to access the BS 110 (e.g., Non-Standalone (NSA) mode or Standalone (SA) mode). During handover, the source BS 110 can instruct the UE 108 to implement a specific RACH TX DNN architecture, and the target BS 110 can optimize one or both of the RACH RX DNN architecture and the RACH RX DNN parameters based on metrics, such as the signal-to-noise ratio (SNR) associated with received UE signals. The source or primary BS 110 can send dedicated RRC messages that include RACH configuration information 120 to the UE during handover or during the addition of secondary cells (for dual connectivity).

The RACH configuration information 120, in at least some embodiments, includes one or more different types of information that the DNN(s) of the UE 108 use as input to generate and configure one or RACH signals 124. For example, the RACH configuration information 120, in at least some embodiments, includes information such as an instruction to use CFRA or CBRA (two-step or four-step), the number of RACH occasions available per Synchronization Signal Block (SSB), the number of available contention-based preambles, the preamble format to use, frequency domain resources, time-domain resources (slots and symbols), initial power for PRACH transmission, and so on. The RACH configuration information 120 can also include the DNN architecture (including the DNN weights and biases) for the UE 108 to apply for PRACH transmission (Msg1/MsgA) and reception of RAR signals (Msg2/MsgB). For example, a RACH DNN configuration can indicate that the waveform generated by the PRACH TX DNN 118 is only to be used by the UE 108 in certain resource blocks, certain frequency bands (e.g., sub-6 Gigahertz (GHz) or millimeter wave (mmWave)), certain time periods, or certain other time, frequency, or time-frequency resources. The RACH configurations can also specify different sets of DNNs, such as contention-based DNNs, contention-free DNNs, and so on.

In at least some embodiments, the RACH configuration information 120 indicates which UE RACH DNNs (e.g., UE PRACH TX DNN(s) 118 and UE RAR RX DNN(s) 130) the UE 108 is to use. The RACH configuration information 120 can configure the UE 108 to use a new/different PRACH TX DNN 118 after the expiry of a backoff period when a RACH procedure fails. Alternatively, the RACH configuration information 120 can configure the UE 108 to use the same PRACH TX DNN 118 architecture when a RACH procedure fails but with one or both of higher transmit power and different DNN weights. If the UE 108 implements multiple RACH DNNs, the UE 108 can randomly select one or both of a PRACH TX DNN(s) 118 and a RAR RX DNN(s) 130 from configurations indicated in a BS message, such as a RACH DNN configuration message. Also, the UE 108 can randomly select the weights of a RACH DNN, such as the PRACH TX DNN 118 or the RAR RX DNN 130, from a set of weights indicated by the BS 110 in a message, such as a DNN configuration message. In some embodiments, a PRACH TX DNN 118 selected by the UE 108 can have a corresponding RAR RX DNN 130 for the RAR signal 150 received by the UE 108 from the BS 110. For example, if the UE 108 selects a particular PRACH TX DNN 118 to transmit a RACH signal 124 to the BS 110, the UE 108 selects a corresponding RAR RX DNN 130 for receiving and processing a RAR signal 150 from the BS 110.

As noted above and described in greater detail herein, both the UE 108 and BS 110, respectively, employ one or more DNNs or other neural networks that are trained or jointly trained and selected based on context-specific parameters to facilitate the overall RACH process. To manage the joint training, selection, and maintenance of these neural networks, the system 100, in at least one embodiment, further includes a managing infrastructure component 154 (or “managing component 154” for purposes of brevity). This managing component 154 can include, for example, a server or other component within the network infrastructure 106 of the wireless communication system 100. The managing component 154 can also include a component external to the wireless communication system 100, such as a cloud server or other computing device. Further, although depicted in the illustrated example as a separate component, the BS 110, in at least some embodiments, implements the managing component 154. The oversight functions provided by the managing component 154 can include, for example, some or all of overseeing the joint training of the neural networks, managing the selection of a particular neural network architecture configuration for the UE 108 or BS 110 based on their specific capabilities or other component-specific parameters, receiving and processing capability updates for purposes of neural network configuration selection, receiving and processing feedback for purposes of neural network training or selection, and the like.

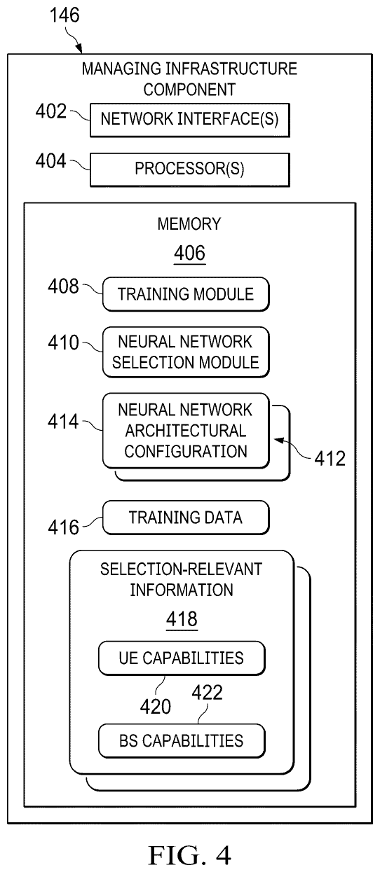

As described below in more detail with respect to FIG. 4, the managing component 154, in some embodiments, maintains a set 412 (FIG. 4) of candidate neural network architectural configurations 414 (FIG. 4). The managing component 154 (or another network component) selects the candidate neural network architectural configurations 414 to be employed at a particular component in the corresponding RACH path based at least in part on the capabilities of the component implementing the corresponding neural network, the capabilities of other components in the transmission chain, the capabilities of other components in the receiving chain or a combination thereof. These capabilities can include, for example, sensor capabilities, processing resource capabilities, battery/power capabilities, RF antenna capabilities, capabilities of one or more accessories of the component, and the like. The information representing these capabilities for the UE 108 and the BS 110 is obtained by and stored at the managing component 154 as expanded UE capability information 420 (FIG. 4) and expanded BS capability information 422 (FIG. 4), respectively. In at least some embodiments, the managing component 154 further considers parameters or other aspects of the corresponding channel or the propagation channel of the environment, such as the carrier frequency of the channel, the known presence of objects or other interferers, and the like.

In support of this approach, in some embodiments, the managing component 154 can manage the joint training of different combinations of candidate neural network architectural configurations 414 for different capability/context combinations. The managing component 154 then can obtain capability information 420 from the UE 108, capability information 422 from the BS 110, or both, and from this capability information, the managing component 154 selects neural network architectural configurations from the set 412 of candidate neural network architectural configurations 414 for each component at least based in part on the corresponding indicated capabilities, RF signaling environment, and the like. In at least some embodiments, the managing component 154 (or another network component) jointly trains the candidate neural network architectural configurations as paired subsets, such that each candidate neural network architectural configuration for a particular capability set for the UE 108 is jointly trained with a single corresponding candidate neural network architectural configuration for a particular capability set for the BS 110. In other embodiments, the managing component 154 (or another network component) the candidate neural network architectural configurations such that each candidate configuration for the UE 108 has a one-to-many correspondence with multiple candidate configurations for the BS 110 and vice versa.

Thus, in at least some embodiments, the system 100 implements a Random Access approach that relies on one or more individually trained and managed neural networks at one or more of the UE 108 or BS 110, or managed, jointly trained, and selectively employed set of neural networks between one or more UEs 108 and one or more BSs 110 for RACH techniques, rather than independently designed process blocks that have been specifically designed for compatibility. Not only does this provide for improved flexibility, but in some circumstances can provide for more rapid processing at each device, as well as the more efficient transmission and processing of RACH-related signals.

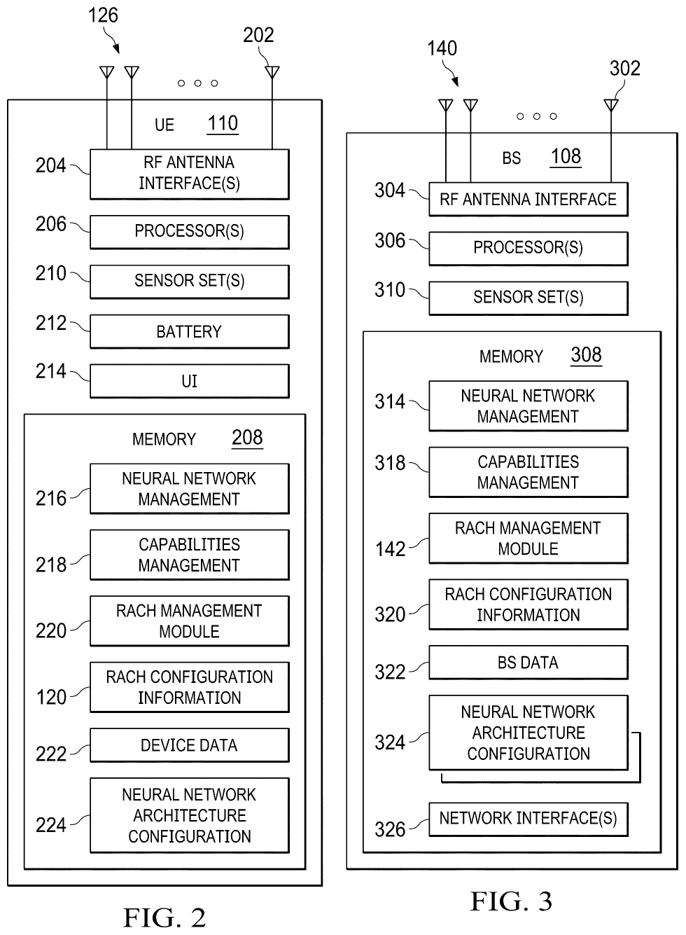

FIG. 2 illustrates example hardware configurations for the UE 108 in accordance with some embodiments. Note that the depicted hardware configuration represents the processing components and communication components most directly related to the neural-network-based processes of one or more embodiments and omit certain components well-understood to be frequently implemented in such electronic devices, such as displays, non-sensor peripherals, external power supplies, and the like.

In the depicted configuration, the UE 108 includes the RF front end 126 having one or more antennas 202 and an RF antenna interface 204 having one or more modems to support one or more RATs. The RF front end 126 operates, in effect, as a physical (PHY) transceiver interface to conduct and process signaling between one or more processors 206 of the UE 108 and the antennas 202 to facilitate various types of wireless communication. The antennas 202 can be arranged in one or more arrays of multiple antennas configured similar to or different from each other and can be tuned to one or more frequency bands associated with a corresponding RAT. The one or more processors 206 can include, for example, one or more central processing units (CPUs), graphics processing units (GPUs), tensor processing units (TPUs) or other application-specific integrated circuits (ASIC), and the like. To illustrate, the processors 206 can include an application processor (AP) utilized by the UE 108 to execute an operating system and various user-level software applications, as well as one or more processors utilized by modems or a baseband processor of the RF front end 126. The UE 108 further includes one or more computer-readable media 208 that include any of a variety of media used by electronic devices to store data and/or executable instructions, such as random access memory (RAM), read-only memory (ROM), caches, Flash memory, solid-state drive (SSD) or other mass-storage devices, and the like. For ease of illustration and brevity, the computer-readable media 208 is referred to herein as “memory 208” in view of frequent use of system memory or other memory to store data and instructions for execution by the processor 206, but it will be understood that reference to “memory 208” shall apply equally to other types of storage media unless otherwise noted.

In at least one embodiment, the UE 108 further includes a plurality of sensors, referred to herein as a sensor set 210, at least some of which are utilized in the neural-network-based schemes of one or more embodiments. Generally, the sensors of the sensor set 210 include those sensors that sense some aspect of the environment of the UE 108 or the use of the UE 108 by a user which have the potential to sense a parameter that has at least some impact on or reflects, for example, the speed of the UE 108, a location of the UE 108, an orientation of the UE 108, movement, or a combination thereof. The sensors of the sensor set 210 can include one or more sensors for object detection, such as radar sensors, lidar sensors, imaging sensors, structured-light-based depth sensors, and the like. The sensor set 210 also can include one or more sensors for determining a position or pose/orientation of the UE 108, such as satellite positioning sensors including GPS sensors, Global Navigation Satellite System (GNSS) sensors, IMU sensors, visual odometry sensors, gyroscopes, tilt sensors or other inclinometers, ultrawideband (UWB)-based sensors, and the like. Other examples of types of sensors of the sensor set 210 can include environmental sensors, such as temperature sensors, barometers, altimeters, and the like or imaging sensors, such as cameras for image capture by a user, cameras for facial detection, cameras for stereoscopy or visual odometry, light sensors for detection of objects in proximity to a feature of the device, object detection sensors (e.g., radar sensors, lidar sensors, imaging sensors, or structured-light-based depth sensors), and the like. The UE 108 further can include one or more batteries 212 or other portable power sources, as well as one or more user interface (UI) components 214, such as touch screens, user-manipulable input/output devices (e.g., “buttons” or keyboards), or other touch/contact sensors, microphones, or other voice sensors for capturing audio content, image sensors for capturing video content, thermal sensors (such as for detecting proximity to a user), and the like.

The one or more memories 208 of the UE 108 store one or more sets of executable software instructions and associated data that manipulate the one or more processors 206 and other components of the UE 108 to perform the various functions attributed to the UE 108. The sets of executable software instructions include, for example, an operating system (OS) and various drivers (not shown), and various software applications. The sets of executable software instructions further include one or more of a neural network management module 216, a capabilities management module 218, or a RACH management module 220. The neural network management module 216 implements one or more neural networks for the UE 108, as described in detail below. The capabilities management module 218 determines various capabilities of the UE 108 that pertain to neural network configuration or selection and reports such capabilities to the managing component 154, as well as monitors the UE 108 for changes in such capabilities, including changes in RF and processing capabilities, changes in accessory availability or capability, changes in sensor availability, and the like, and manages the reporting of such capabilities, and changes in the capabilities, to the managing component 154. The RACH management module 220 operates to perform one or more conventional (non-DNN) RACH operations when the UE 108 is not implementing a corresponding RACH DNN, or a RACH DNN is not configured to perform a particular RACH operation.

To facilitate the operations of the UE 108, the one or more memories 208 of the UE 108 further can store data associated with these operations. This data can include, for example, RACH configuration information 120, device data 222, and one or more neural network architecture configurations 224. The RACH configuration information 120 represents, for example, an instruction from the BS 110 to use CFRA or CBRA (two-step or four-step), the number of RACH occasions available per SSB, the number of available contention-based preambles, the preamble format to use, frequency domain resources, time-domain resources (slots and symbols), initial power for PRACH transmission, and so on. The device data 222 represents, for example, user data, multimedia data, beamforming codebooks, software application configuration information, and the like.

The device data 222 further can include capability information for the UE 108, such as sensor capability information regarding the one or more sensors of the sensor set 210, including the presence or absence of a particular sensor or sensor type, and, for those sensors present, one or more representations of their corresponding capabilities, such as range and resolution for lidar or radar sensors, image resolution and color depth for imaging cameras, and the like. The capability information further can include information regarding, for example, the capabilities or status of the battery 212, the capabilities or status of the UI 214 (e.g., screen resolution, color gamut, or frame rate for a display), and the like.

The one or more neural network architecture configurations 224 represent UE-implemented examples selected from the set 412 of candidate neural network architectural configurations 414 maintained by the managing component 154. Each neural network architecture configuration 224 includes one or more data structures containing data and other information representative of a corresponding architecture and/or parameter configurations used by the neural network management module 216 to form a corresponding neural network of the UE 108. The information included in a neural network architectural configuration 224 includes, for example, parameters that specify a fully connected layer neural network architecture, a convolutional layer neural network architecture, a recurrent neural network layer, a number of connected hidden neural network layers, an input layer architecture, an output layer architecture, a number of nodes utilized by the neural network, coefficients (e.g., weights and biases) utilized by the neural network, kernel parameters, a number of filters utilized by the neural network, strides/pooling configurations utilized by the neural network, an activation function of each neural network layer, interconnections between neural network layers, neural network layers to skip, and so forth. Accordingly, the neural network architecture configuration 224 includes any combination of NN formation configuration elements (e.g., architecture and/or parameter configurations) for creating a NN formation configuration (e.g., a combination of one or more NN formation configuration elements) that defines and/or forms a DNN.

FIG. 3 illustrates example hardware configurations for the BS 110 in accordance with some embodiments. Note that the depicted hardware configuration represents the processing components and communication components most directly related to the neural-network-based processes of one or more embodiments and omit certain components well-understood to be frequently implemented in such electronic devices, such as displays, non-sensor peripherals, external power supplies, and the like. Further note that although the illustrated diagram represents an implementation of the BS 110 as a single network node (e.g., a 5G NR Node B, or “gNB”), the functionality, and thus the hardware components, of the BS 110 instead can be distributed across multiple network nodes or devices and can be distributed in a manner to perform the functions of one or more embodiments.

In the depicted configuration, the BS 110 includes the RF front end 140 having one or more antennas 302 and an RF antenna interface (or front end) 304 having one or more modems to support one or more RATs and which operates as a PHY transceiver interface to conduct and process signaling between one or more processors 306 of the BS 110 and the antennas 302 to facilitate various types of wireless communication. The antennas 302 can be arranged in one or more arrays of multiple antennas configured similar to or different from each other and can be tuned to one or more frequency bands associated with a corresponding RAT. The one or more processors 306 can include, for example, one or more CPUs, GPUs, TPUs or other ASICs, and the like. The BS 110 further includes one or more computer-readable media 308 that include any of a variety of media used by electronic devices to store data and/or executable instructions, such as RAM, ROM, caches, Flash memory, SSD or other mass-storage devices, and the like. As with the memory 208 of the UE 108, for ease of illustration and brevity, the computer-readable media 308 is referred to herein as “memory 308” in view of frequent use of system memory or other memory to store data and instructions for execution by the processor 306, but it will be understood that reference to “memory 308” shall apply equally to other types of storage media unless otherwise noted.

The BS also includes one or more network interfaces 326 to the core network 102, other BSs, and so on. In at least one embodiment, the BS 110 further includes a plurality of sensors, referred to herein as a sensor set 310, at least some of which are utilized in the neural-network-based schemes of one or more embodiments. Generally, the sensors of the sensor set 310 include those sensors that sense some aspect of the environment of the BS 110 and which have the potential to sense a parameter that has at least some impact on or reflects an RF propagation path of or RF transmission/reception performance by, the BS 110 relative to the corresponding UE 108. The sensors of the sensor set 310 can include one or more sensors for object detection, such as radar sensors, lidar sensors, imaging sensors, structured-light-based depth sensors, and the like. If the BS 110 is a mobile BS, the sensor set 310 also can include one or more sensors for determining a position or pose/orientation of the BS 110. Other examples of types of sensors of the sensor set 310 can include imaging sensors, light sensors for detecting objects in proximity to a feature of the BS 110, and the like.

The one or more memories 308 of the BS 110 store one or more sets of executable software instructions and associated data that manipulate the one or more processors 306 and other components of the BS 110 to perform the various functions of one or more embodiments and attributed to the BS 110. The sets of executable software instructions include, for example, an OS and various drivers (not shown) and various software applications. The sets of executable software instructions further include one or more of a neural network management module 314, a RACH management module 142, or a capabilities management module 318.

The neural network management module 314 implements one or more neural networks for the BS 110, as described in detail below. The RACH management module 142 operates to perform one or more conventional (non-DNN) RACH operations when the BS 110 is not implementing a corresponding RACH DNN, or a RACH DNN is not configured to perform a particular RACH operation. The capabilities management module 318 determines various capabilities of the BS 110 that pertain to neural network configuration or selection and reports such capabilities to the managing component 154, as well as monitors the BS 110 for changes in such capabilities, including changes in RF and processing capabilities, and the like, and manages the reporting of such capabilities, and changes in the capabilities, to the managing component 154.

To facilitate the operations of the BS 110, the one or more memories 308 of the BS 110 further can store data associated with these operations. This data can include, for example, RACH configuration information 320, BS data 322, and one or more neural network architecture configurations 324. The RACH configuration information 320 represents, for example, the RACH configuration information 320 an indication of whether CFRA or CBRA (two-step or four-step) is to be performed by the BS 110 with respect to a given UE 108, the number of RACH occasions available per SSB indicated to a UE 108 by the BS 110, the number of available contention-based preambles indicated to a UE 108 by the BS 110, the preamble assigned to a UE 108 by the BS 110, the frequency domain resources assigned to the UE 108 by the BS 110, time-domain resources (slots and symbols) assigned to a UE 108 by the BS 110, the initial power for PRACH transmission indicated to a UE 108 by the BS 110, and so on.

The BS data 322 represents, for example, beamforming codebooks, software application configuration information, and the like. The BS data 322 further can include capability information for the BS 110, such as sensor capability information regarding the one or more sensors of the sensor set 310, including the presence or absence of a particular sensor or sensor type, and, for those sensors present, one or more representations of their corresponding capabilities, such as range and resolution for lidar or radar sensors, image resolution and color depth for imaging cameras, and the like. The one or more neural network architecture configurations 324 represent BS-implemented examples selected from the set 412 of candidate neural network architectural configurations 414 maintained by the managing component 154. Thus, as with the neural network architectural configurations 224 of FIG. 2, each neural network architecture configuration 324 includes one or more data structures containing data and other information representative of a corresponding architecture and/or parameter configurations used by the neural network management module 314 to form a corresponding neural network of the BS 110.

FIG. 4 illustrates an example hardware configuration for the managing component 154 in accordance with some embodiments. Note that the depicted hardware configuration represents the processing components and communication components most directly related to the neural-network-based processes of one or more embodiments and omit certain components well-understood to be frequently implemented in such electronic devices. Further, although the hardware configuration is depicted as being located at a single component, the functionality, and thus the hardware components, of the managing component 154 instead can be distributed across multiple infrastructure components or nodes and can be distributed in a manner to perform the functions of one or more embodiments.

As noted above, any of a variety of components, or a combination of components, within the network infrastructure 106 can implement the managing component 154. For ease of illustration, the managing component 154 is described with reference to an example implementation as a server or another component in one of the core networks 102, but in other embodiments, the managing component 154 is implemented as, for example, part of a BS 110.

As shown, the managing component 154 includes one or more network interfaces 402 (e.g., an Ethernet interface) to couple to one or more networks of the system 100, one or more processors 404 coupled to the one or more network interfaces 402, and one or more non-transitory computer-readable storage media 406 (referred to herein as a “memory 406” for brevity) coupled to the one or more processors 404. The one or more memories 406 stores one or more sets of executable software instructions and associated data that manipulate the one or more processors 404 and other components of the managing component 154 to perform the various functions of one or more embodiments and attributed to the managing component 154. The sets of executable software instructions include, for example, an OS and various drivers (not shown).

The software stored in the one or more memories 406 further can include one or more of a training module 408 or a neural network selection module 410. The training module 408 operates to manage the individual training and joint training of candidate neural network architectural configurations 414 for the set 412 of candidate neural networks available to be employed at the transmitting and receiving devices in a RACH path using one or more sets of training data 416. The training can include training neural networks while offline (that is, while not actively engaged in processing the communications) and/or online (that is, while actively engaged in processing the communications). For example, the training module 408 can individually or jointly train the RACH DNNs implemented by at least one of the TX and RX processing modules of the UE 108 and BS 110 using one or more sets of training data to provide RACH functionality. The offline or online training processes can implement different RACH parameters for different RACH scenarios, such as initial RRC connection setup, RRC connection re-establishment, handover, downlink data arrival, uplink data arrival, scheduling request failure, New Radio (NR) cell addition for dual connectivity, beam recovery, and so on.

In at least some embodiments, the training module 408 also trains the RACH DNNs for different RA configurations, such as CFRA, two-step CFRA/CBRA, or four-step CBRA. The training module 408 can jointly train CFRA TX and RX DNNs, two-step CFRA/CBRA TX and RX DNNs, and four-step CBRA TX and RX DNNs with each other. In some embodiments, the training module 408 collectively trains the TX DNNs and the RX DNNs of a BS 110 and neighboring cells to minimize the impact of co-channel interference. Also, the training module 408 can jointly train a TX DNN of a UE 108 with a corresponding RX DNN of the UE 108 and jointly train an RX DNN of a BS 110 with a TX DNN of the BS 110. In other embodiments, the training module 408 jointly trains individual or one or more pairs of TX and RX DNNs of a UE 108 with one or more corresponding individual or pairs of RX and TX DNNs of a BS(s) 110. In at least some embodiments, the training module 408 trains the RACH DNNs for UEs 108 based on one or both of the cell size of the BS 110 and a selection of RACH DNNs of other cells. For example, the training module 408 trains the RACH DNNs such that the RACH DNNs of neighboring cells generate different RACH sequences to reduce the possibility of a first BS detecting a RACH from a UE attempting to connect with a second BS.

The training module 408 can implement offline training by collecting RACH-related metrics while the BS 110 is being installed/updated or by using a simulation environment. In addition, the training module 408 can implement online training during handover procedures or the addition of secondary cell groups so that the training module 408 can estimate RACH performance and update the RACH DNNs via gradient descent. Moreover, the training can be individual or separate, such that each RACH DNN is individually trained on its own training data set without the result being communicated to, or otherwise influencing, the RACH DNN training at the opposite end of the transmission path or the training can be joint training, such that the RACH DNNs in a data stream transmission path are jointly trained on the same, or complementary, data sets.

The neural network selection module 410 operates to obtain, filter, and otherwise process selection-relevant information 418 from one or both of a UE 108 or a BS 110 in the RACH path and using this selection-relevant information 418 select individual or a pair of jointly trained neural network architectural configurations 414 from a candidate set 412 for implementation at the transmitting device and the receiving device in the RACH path. As noted above, this selection-relevant information 418 can include, for example, one or more of UE capability information 420 or BS capability information 422, current propagation path information, channel-specific parameters, and the like. After the neural network selection module 410 has made a selection, the neural network selection module 410 then initiates the transmission of an indication of the neural network architectural configuration 414 selected for each network component, such as via transmission of an index number associated with the selected configuration, transmission of one or more data structures representative of the neural network architectural configuration itself, or a combination thereof.

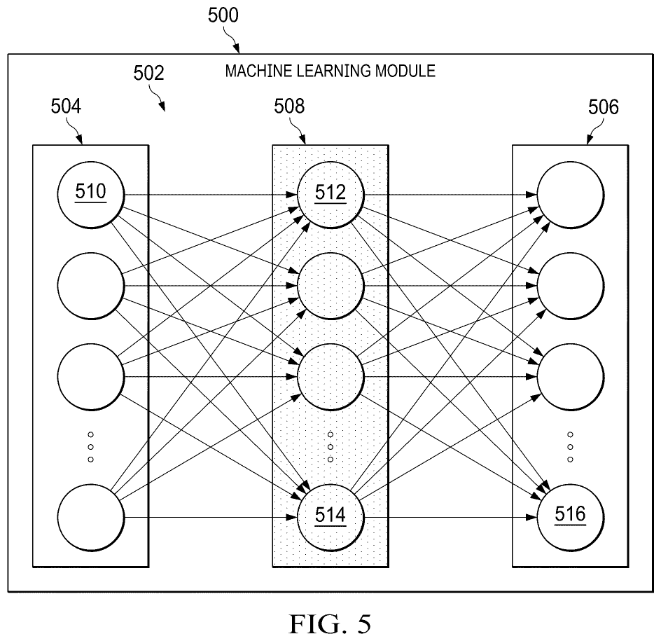

FIG. 5 illustrates an example machine learning (ML) module 500 for implementing a neural network in accordance with some embodiments. At least one UE 108 and BS 110 in a RACH path 114 implement one or more RACH DNNs or other neural networks for one or more of transmitting RACH signals, processing RACH signals, transmitting RAR signals, processing RAR signals, transmitting PUSCH signals, processing PUSCH signals, transmitting CR signals, processing CR signals, and so on. The ML module 500, therefore, illustrates an example module for implementing one or more of these neural networks.

In the depicted example, the ML module 500 implements at least one deep neural network (DNN) 502 with groups of connected nodes (e.g., neurons and/or perceptrons) organized into three or more layers. The nodes between layers are configurable in a variety of ways, such as a partially connected configuration where a first subset of nodes in a first layer is connected with a second subset of nodes in a second layer, a fully connected configuration where each node in a first layer is connected to each node in a second layer, etc. A neuron processes input data to produce a continuous output value, such as any real number between 0 and 1. In some cases, the output value indicates how close the input data is to a desired category. A perceptron performs linear classifications on the input data, such as a binary classification. The nodes, whether neurons or perceptrons, can use a variety of algorithms to generate output information based upon adaptive learning. Using the DNN 502, the ML module 500 performs a variety of different types of analysis, including single linear regression, multiple linear regression, logistic regression, stepwise regression, binary classification, multiclass classification, multivariate adaptive regression splines, locally estimated scatterplot smoothing, and so forth.

In some implementations, the ML module 500 adaptively learns based on supervised learning. In supervised learning, the ML module 500 receives various types of input data as training data. The ML module 500 processes the training data to learn how to map the input to a desired output. As one example, the ML module 500, when implemented in a UE PRACH signal TX mode, receives one or more of RACH configuration information, UE sensor data or related information, capability information of UEs 108, capability information of BSs 110, operating environment characteristics of the UEs 1108, operating environment characteristics of the BSs 110, or the like as input and learns how to map this input training data to, for example, one or more configured output RACH signals for transmission to a BS 110. As another example, the ML module 500, when implemented in a BS PRACH signal RX mode, receives as input one or more of representations of received RACH signals (e.g., an individual PRACH signal, a PUSCH signal in combination with the PRACH signal, or an individual PUSCH signal) and learns how to map this input training data to an output representing, for example, one or more of a RACH signal type indicator, UL TX timing/advance estimation, RAR information, CR information, or the like. In another example, the ML module 500, when implemented in a BS RAR signal TX mode, receives one or more of RACH signal type indicators, UL TX timing/advance estimation, RAR information, CR information, or the like as input and learns how to generate one or more configured output RAR (or CR) signals (e.g., an individual RAR signal, a CR signal in combination with the RAR signal, or an individual CR signal) for transmission to a UE 108. As yet another example, the ML module 500, when implemented in a UE RAR signal RX mode, receives one or more of RAR (or CR) signals, RAR information, CR information, or the like as input and learns how to generate an output representing an indication of RACH success or RACH failure. In at least some embodiments, the training in either or both of the TX mode or the RX mode further can include training using sensor data as input, capability information as input, RF antenna configuration or other operational parameter information as input, and the like.

During a training procedure, the ML module 500 uses labeled or known data as an input to the DNN 502. The DNN 502 analyzes the input using the nodes and generates a corresponding output. The ML module 500 compares the corresponding output to truth data and adapts the algorithms implemented by the nodes to improve the accuracy of the output data. Afterward, the DNN 502 applies the adapted algorithms to unlabeled input data to generate corresponding output data. The ML module 500 uses one or both of statistical analysis and adaptive learning to map an input to an output. For instance, the ML module 500 uses characteristics learned from training data to correlate an unknown input to an output that is statistically likely within a threshold range or value. This allows the ML module 500 to receive complex input and identify a corresponding output. In some implementations, a training process trains the ML module 500 on characteristics of communications transmitted over a wireless communication system (e.g., time/frequency interleaving, time/frequency deinterleaving, convolutional encoding, convolutional decoding, power levels, channel equalization, inter-symbol interference, quadrature amplitude modulation/demodulation, frequency-division multiplexing/de-multiplexing, transmission channel characteristics) concurrent with characteristics of data encoding/decoding schemes employed in such systems. This allows the trained ML module 500 to receive samples of a signal as an input and recover information from the signal, such as the binary data embedded in the signal.

In the depicted example, the DNN 502 includes an input layer 504, an output layer 506, and one or more hidden layers 508 positioned between the input layer 504 and the output layer 506. Each layer has an arbitrary number of nodes, where the number of nodes between layers can be the same or different. That is, the input layer 504 can have the same number and/or a different number of nodes as output layer 506, the output layer 506 can have the same number and/or a different number of nodes than the one or more hidden layer 508, and so forth.

Node 510 corresponds to one of several nodes included in input layer 504, wherein the nodes perform separate, independent computations. As further described, a node receives input data and processes the input data using one or more algorithms to produce output data. Typically, the algorithms include weights and/or coefficients that change based on adaptive learning. Thus, the weights and/or coefficients reflect information learned by the neural network. Each node can, in some cases, determine whether to pass the processed input data to one or more next nodes. To illustrate, after processing input data, node 510 can determine whether to pass the processed input data to one or both of node 512 and node 514 of hidden layer 508. Alternatively or additionally, node 510 passes the processed input data to nodes based upon a layer connection architecture. This process can repeat throughout multiple layers until the DNN 502 generates an output using the nodes (e.g., node 516) of output layer 506.

A neural network can also employ a variety of architectures that determine what nodes within the neural network are connected, how data is advanced and/or retained in the neural network, what weights and coefficients the neural network is to use for processing the input data, how the data is processed, and so forth. These various factors collectively describe a neural network architecture configuration, such as the neural network architecture configurations briefly described above. To illustrate, a recurrent neural network, such as a long short-term memory (LSTM) neural network, forms cycles between node connections to retain information from a previous portion of an input data sequence. The recurrent neural network then uses the retained information for a subsequent portion of the input data sequence. As another example, a feed-forward neural network passes information to forward connections without forming cycles to retain information. While described in the context of node connections, it is to be appreciated that a neural network architecture configuration can include a variety of parameter configurations that influence how the DNN 502 or other neural network processes input data.

A neural network architecture configuration of a neural network can be characterized by various architecture and/or parameter configurations. To illustrate, consider an example in which the DNN 502 implements a convolutional neural network (CNN). Generally, a convolutional neural network corresponds to a type of DNN in which the layers process data using convolutional operations to filter the input data. Accordingly, the CNN architecture configuration can be characterized by, for example, pooling parameter(s), kernel parameter(s), weights, and/or layer parameter(s).

A pooling parameter corresponds to a parameter that specifies pooling layers within the convolutional neural network that reduce the dimensions of the input data. To illustrate, a pooling layer can combine the output of nodes at a first layer into a node input at a second layer. Alternatively or additionally, the pooling parameter specifies how and where in the layers of data processing the neural network pools data. A pooling parameter that indicates “max pooling,” for instance, configures the neural network to pool by selecting a maximum value from the grouping of data generated by the nodes of a first layer and use the maximum value as the input into the single node of a second layer. A pooling parameter that indicates “average pooling” configures the neural network to generate an average value from the grouping of data generated by the nodes of the first layer and uses the average value as the input to the single node of the second layer.

A kernel parameter indicates a filter size (e.g., a width and a height) to use in processing input data. Alternatively or additionally, the kernel parameter specifies a type of kernel method used in filtering and processing the input data. A support vector machine, for instance, corresponds to a kernel method that uses regression analysis to identify and/or classify data. Other types of kernel methods include Gaussian processes, canonical correlation analysis, spectral clustering methods, and so forth. Accordingly, the kernel parameter can indicate a filter size and/or a type of kernel method to apply in the neural network. Weight parameters specify weights and biases used by the algorithms within the nodes to classify input data. In some implementations, the weights and biases are learned parameter configurations, such as parameter configurations generated from training data. A layer parameter specifies layer connections and/or layer types, such as a fully-connected layer type that indicates to connect every node in a first layer (e.g., output layer 506) to every node in a second layer (e.g., hidden layer 508), a partially-connected layer type that indicates which nodes in the first layer to disconnect from the second layer, an activation layer type that indicates which filters and/or layers to activate within the neural network, and so forth. Alternatively or additionally, the layer parameter specifies types of node layers, such as a normalization layer type, a convolutional layer type, a pooling layer type, and the like.

While described in the context of pooling parameters, kernel parameters, weight parameters, and layer parameters, it will be appreciated that other parameter configurations can be used to form a DNN consistent with the guidelines provided herein. Accordingly, a neural network architecture configuration can include any suitable type of configuration parameter that a DNN can apply that influences how the DNN processes input data to generate output data.

The architectural configuration of the ML module 500, in at least some embodiments, is based on capabilities (including sensors) of the node implementing the ML module 500 of one or more nodes upstream or downstream of the node implementing the ML module 500, or a combination thereof. For example, the UE 108 has one or more sensors enabled or disabled or has battery power limited. Thus, in this example, the ML modules 500 for both the UE 108 and the BS 110 is trained based on different sensor configurations of a UE 108 or battery power as an input to facilitate, for example, the ML modules 500 at both ends to employ RACH techniques that are better suited to different sensor configurations of a UE 108 or lower power consumption. Accordingly, in some embodiments, the device implementing the ML module 500 is configured to implement different neural network architecture configurations for different combinations of capability parameters, sensor parameters, RF environment parameters, operational parameters, and the like. For example, a device has access to one or more neural network architectural configurations for use depending on the current state of the UE battery 212.

In at least some embodiments, the device implementing the ML module 500 locally stores some or all of a set of candidate neural network architectural configurations that the ML module 500 can employ. For example, a component can index the candidate neural network architectural configurations by a look-up table (LUT) or other data structure that takes as inputs one or more parameters, such as one or more UE capability parameters, one or more BS capability parameters, one or more UE operating parameters, one or more BS operating parameters, one or more channel parameters, and the like, and outputs an identifier associated with a corresponding locally-stored candidate neural network architectural configuration that is suited for operation in view of the input parameter(s). However, in some embodiments, the neural network employed at the UE 108 and the neural network employed at the BS 110 are jointly trained, and thus a mechanism is be employed between the UE 108 and BS 110 to help ensure that each device selects for its ML module 500 a neural network architectural configuration that has been jointly trained with, or at least is operationally compatible with, the neural network architectural configuration the other device has selected for its complementary ML module 500. This mechanism can include, for example, coordinating signaling transmitted between UE 108 and BS 110 directly or via the managing component 154, or the managing component 154 can serve as a referee that selects a compatible jointly trained pair of architectural configurations from a subset proposed by each device.

In other embodiments, it can be more efficient or otherwise advantageous to have the managing component 154 operate to select the appropriate jointly trained pair of neural network architectural configurations to be employed at the counterpart ML modules 500 at the transmitting device and receiving device. In this approach, the managing component 154 obtains information representing some or all of the parameters that can be used in the selection process from the transmitting and receiving devices, and from this information selects a jointly trained pair of neural network architectural configurations 414 from the set 412 of such configurations maintained at the managing component 154. The managing component 154 (or another network component), in at least some embodiments, implements this selection process using, for example, one or more algorithms, a LUT, and the like. The managing component 154 then transmits to each device either an identifier or another indication of the neural network architectural configuration selected for the ML module 500 of that device (in the event that each device has a locally stored copy), or the managing component 154 transmits one or more data structures representative of the neural network architectural configuration selected for that device.

To facilitate the process of selecting an appropriate individual neural network architectural configuration or pair of neural network architectural configurations for the transmitting and receiving devices, in at least one embodiment, the managing component 154 trains the ML modules 500 in a RACH path 114 using a suitable combination of the neural network management modules and training modules. The training can occur offline when no active communication exchanges are occurring or online during active communication exchanges. For example, the managing component 154 can mathematically generate training data, access files that store the training data, obtain real-world communications data, etc. The managing component 154 then extracts and stores the various learned neural network architecture configurations for subsequent use. Some implementations store input characteristics with each neural network architecture configuration, whereby the input characteristics describe various properties of one or both of UE 108 or BS 110 operating characteristics and capability configuration corresponding to the respective neural network architecture configurations. In implementations, a neural network manager selects a neural network architecture configuration by matching a current operating environment of one or more of the UE 108 or BS 110 to the input characteristics, with the current operating environment including indications of capabilities of one or more nodes along the training RACH path, such as sensor capabilities, RF capabilities, processing capabilities, and the like.

As noted, network devices that are in wireless communication, such as UE 108 or BS 110, can be configured to process wireless communication exchanges using one or more DNNs at each networked device, where each DNN replaces and/or adds new functionality to one or more functions conventionally implemented by one or more hard-coded or fixed-design blocks in furtherance of a RACH process. Moreover, each DNN can further incorporate current sensor data from one or more sensors of a sensor set of the networked device and/or capability data from some or all of the nodes in the RACH path 114 to, in effect, modify or otherwise adapt its operation to account for the current operational environment.

To this end, FIG. 6 illustrates an example operating environment 600 for DNN implementation in the example RACH path 114 of FIG. 1. In the illustrated example, the operating environment 600 employs a neural-network-based approach for facilitating RACH operations. In at least one embodiment, the neural network management module 216 of the UE 108 implements a UE PRACH TX processing module 618, while the neural network management module 314 of the BS 110 implements a BS PRACH RX processing module 638. The neural network management module 314 of the BS 110 further implements a BS RAR TX processing module 646, while the neural network management module 216 of the UE 108 further implements a UE RAR RX processing module 630.

In at least some embodiments, one or more of these processing modules implement at least one DNN via the implementation of a corresponding ML module, such as described above with reference to the one or more DNNs 502 of the ML module 500 of FIG. 5. As an example, the UE PRACH TX processing module 618 implements the UE PRACH TX DNN 118, the BS PRACH RX processing module 638 implements the BS PRACH RX DNN 138, the BS RAR TX processing module 646 implements the BS RAR TX DNN 146, and the UE RAR RX processing module 630 implements the UE RAR RX DNN 130. The UE PRACH TX processing module 618 of the UE 108 and the BS PRACH TX processing module 638 of the BS 110, in at least some embodiments, interoperate to support an uplink neural-network-based wireless communication path between the UE 108 and the BS 110 for generating and communicating data to facilitate RACH operations. Likewise, the BS RAR TX processing module 646 of the BS 110 and the UE RAR processing module 630 of the UE 108, in at least some embodiments, interoperate to support a downlink neural-network-based wireless communication path between the UE 108 and the BS 1101 for generating and communicating data to facilitate RACH operations. In other embodiments, the UE 108 and the BS 110 do not implement all of the DNNs described herein. For example, the BS 110 does not implement any of the DNNs or only implements one of the DNNs.

One or more trained DNNs of the UE PRACH TX processing module 618 of the UE 108 receive input, such as RACH configuration information 120, sensor data 122, payload/data 614 for a PUSCH transmission, or the like. In at least some embodiments, the DNN(s) of the UE PRACH TX processing module 618 receives RACH configuration information 120 from the BS 110 or the RACH management module 220 of the UE 108, as described above with respect to FIG. 1. In one example, the UE PRACH TX processing module 618 receives one or more of the RACH configuration information 120, the payload/data 614, or the sensor data 122 as input during or in response to a RACH-related event, such as initial RRC connection setup, RRC connection re-establishment, handover, downlink data arrival, uplink data arrival, scheduling request failure, New Radio (NR) cell addition for dual connectivity, beam recovery, and so on. In at least some of these RACH-related events, the BS 110 uses dedicated RRC messages to send the RACH configuration information 120 to the UE 108.

In at least some embodiments, the DNN(s) of the UE PRACH TX processing module 618 receives the sensor data 122 (or associated information) from the sensor set 210 of the UE 108. Further, it will be appreciated that the capabilities of the UE 108, including available sensors, can change from moment to moment. For example, the UE 108 disables one or more sensors based on the current battery level, thermal state, or another condition of the UE 108. To compensate for varying sensor capabilities, the managing component 154 (or another component), in at least some embodiments, trains the one or more DNNs of the UE PRACH TX processing module 618 based on different sensor data 122 inputs to provide PRACH TX outputs that take into consideration different sensor capabilities of the UE 108.

From one or more of the RACH configuration information 120 input, the PUSCH data 614, the sensor data input 122, or other relevant input, the one or more DNNs of the UE PRACH TX processing module 618 are trained to generate and configure an output including one or more RACH signals 124. In one example, the one or more DNNs of the UE PRACH TX processing module 618 generate a RACH signal 124 based on a dedicated RACH preamble identified in the RACH configuration information 120. If the RACH configuration information 120 does not indicate a dedicated RACH preamble allocated to the UE 108 by the BS 110, the one or more DNNs of the UE PRACH TX processing module 618 can select a RACH preamble from available contention-based preambles. In one example, the RACH configuration information 120 indicates the available contention-based preambles. The one or more DNNs of the UE PRACH TX processing module 618 can also select a RACH occasion, which is characterized by RACH time-frequency resources associated with a detected or selected SSB, for transmitting the RACH signal 124.

In a Msg1 stage of a CFRA or four-step CBRA configuration, the RACH signal 124 includes a PRACH signal 610 generated using the RACH preamble and configured for transmission by the UE 108 over a PRACH. The PRACH signal 610, in at least some embodiments, is associated with, for example, the ID of the preamble ID (UEID) of the UE 108. In one example, the UEID is an RA Radio Network Temporary Identifier (RA-RNTI) that is implicitly specified by the timing of the preamble transmission. In a MsgA stage of a two-step CFRA/CBRA configuration, the RACH signal 124 includes a PUSCH signal 612 in addition to the PRACH signal 610. For example, the one or more DNNs of the UE PRACH TX processing module 618 receive input, such as PUSCH payload/data 614, a PUSCH assignment, or the like. From this input, the one or more DNNs of the UE PRACH TX processing module 618 generate a RACH signal 124 output, including the PUSCH signal 612 in addition to the PRACH signal 610. The PUSCH signal 612 includes, for example, a payload for a higher protocol layer, an RRC Connection request, and so on. In at least some embodiments, the UE PRACH TX DNN 118 implemented by the UE PRACH TX processing module 618 includes a separate PUSCH TX portion for generating the PUSCH signal 612. In other embodiments, a separate PUSCH TX DNN (not shown) is employed by the UE PRACH TX processing module 618.

The RF antenna interface 204 and one or more antennas 202 of the UE 108 convert the RACH signal 124 output into a corresponding RF signal 616 that is wirelessly transmitted for reception by the BS 110. The RF signal 616 is received and processed at the BS 110 via one or more antennas 302 and the RF antenna interface 304. The one or more DNNs of the BS PRACH RX processing module 638 of the BS 110 are trained to receive the resulting captured RACH signal 124 as input, and from these inputs generate a corresponding output. The DNN(s) of the BS PRACH RX processing module 638, in at least some embodiments, includes a separate PUSCH RX portion for receiving a PUSCH signal 612 from the UE 108. In other embodiments, a separate PUSCH RX DNN is employed by the DNN(s) of the BS PRACH RX processing module 638. In some embodiments, the BS PRACH RX processing module 638 does not implement the DNN(s) and uses one or more conventional mechanisms to receive/process the RACH signal 124 and generate the output. The generated output, in at least some embodiments, includes the RACH signal information 617 and UL TX timing estimates 620.

In at least some embodiments, the BS RACH management module 142 receives the output from the one or more DNNs of the BS PRACH RX processing module 638. The BS RACH management module 142 processes the output, such as the RACH signal information 617 and UL TX timing estimate 620 and generates one or more of corresponding RAR information 622 or CR information 624. The RAR information 622, in at least some embodiments, is generated by the BS RACH management module 142 in response to the BS 110 receiving an individual PRACH signal 610 (Msg1) or a receiving a PRACH signal 610 in addition to a PUSCH signal 612 (MsgA). The CR information 624, in at least some embodiments, is generated by the BS RACH management module 142 in response to receiving an individual PUSCH signal 612 (Msg3) or receiving a PUSCH signal 612 in addition to a PRACH signal 610 (MsgA). The RAR information 622 includes or is associated with, for example, the RACH Preamble Identifier (RAPID) associated with the PRACH signal 610, the UEID, a Cell Radio Network Temporary Identifier (C-RNTI) assigned to the UE 108, a backoff indicator, a timing advance, a UL resource grant, and so on. If the UEID is the RA-RNTI, the RACH management module 142 can derive the UEID from the timeslot number in which the BS 110 receives the PRACH signal 610. The CR information 624 includes, for example, a backoff indicator, fallbackRAR, successRAR, RRC Connection Setup information, and so on. The BS RACH management module 142 can also assign a C-RNTI to the UE 108, which the BS 110 uses to address the UE 108 in subsequent messages. In other embodiments, the one or more DNNs of the BS PRACH RX processing module 638 generate one or both of the RAR information 622 or the CR information 624 instead of the BS RACH management module 142. The one or more DNNs of the BS PRACH RX processing module 638, in at least some embodiments, also assign the C-RNTI to the UE 108.

The BS RACH management module 142 (or the BS PRACH RX processing module 638) provides one or both of the RAR information 622 and the CR information 624 to the BS RAR TX processing module 646 as input. For example, in a Msg2 stage of a CFRA or a four-step CBRA configuration, the BS RAR TX processing module 646 receives the RAR information 622 as input. From this input, the one or more DNNs of the BS RAR TX processing module 646 generate an RAR signal 150 output that is configured for transmission on the Download Shared Channel (DL-SCH), which is carried by the PDSCH. In this configuration, the RAR signal 150 represents a RAR message that includes or is associated with information such as the RAPID of the preamble associated with the PRACH signal 610 transmitted by the UE 108, timing and uplink resource allocation (i.e., timing advance and UL resource grant), a backoff indicator, the C-RNTI, and so on. In a Msg4 stage of a four-step CBRA configuration, the BS RAR TX processing module 646 (or a separate BS CR TX processing module) receives the CR information 624 as input. From this input, the one or more DNNs of the BS RAR TX module 646 (or separate BS CR TX processing module) generate a separate CR signal 1412 output for transmission on a PDSCH instead of the RAR signal 150. The CR signal output represents a CR message that includes, for example, a CR ID corresponding to a UEID of the UE 108, RRC Connection setup information, and so on. In a MsgB stage of a two-step CFRA/CBRA configuration, the BS RAR TX processing module 646 receives both the RAR information 622 and CR information 624 as input. From this input, the one or more DNNs of the BS RAR TX processing module 646 generate a RAR signal 150 output representing a combination of the RAR information 622 and CR information 624 described above. In at least some embodiments, the DNN(s) of BS RAR TX processing module 646 for generating the RAR signal 150 includes a separate CR TX portion for generating the CR signal 1412. In other embodiments, the BS RAR TX processing module 646 implements a separate CR TX DNN. In other embodiments, the BS RAR TX processing module 646 does not implement one or more DNNs and generates the RAR signal 150 using one or more conventional mechanisms.

In at least some embodiments, the output generated by the one or more DNNs of the BS RAR TX processing module 646 (or conventional TX mechanism) includes Downlink Control Information (DCI) associated with the RAR signal 150 (e.g., Msg2/MsgB) or an individual CR signal 1412 (Msg4). The TX neural network (or a conventional TX mechanism) scrambles the DCI with the UEID of the UE 108. The DCI allows for the UE 108 to decode the RAR signal 150 or CR signal 1412 and obtain the RAR information 622 and CR information 624.

The RF antenna interface 304 and one or more antennas 302 of the BS 110 convert the RAR (or CR) signal 150 output into a corresponding RF signal 626 that is wirelessly transmitted for reception by the UE 108. The RF front end 304 transmits the DCI associated with the RAR (or CR) signal 150 on the Physical Downlink Control Channel (PDCCH) and transmits the RAR and CR information associated with RAR (or CR) signal 150 on the DL-SCH, which is carried by the PDSCH. The RF signal 626 is received and processed at the UE 108 via the one or more antennas 202 and the RF antenna interface 204. The one or more DNNs of the UE RAR RX processing module 630 are trained to receive the resulting captured RAR signal 150 or CR signal 1412 as input, and from these inputs generate a corresponding output. The DNN(s) of the UE RAR RX processing module 630, in at least some embodiments, includes a separate CR RX portion for receiving the CR signal 1412. In other embodiments, a separate CR RX DNN is employed by the UE RAR RX processing module 630. However, in at least some embodiments, the UE RAR RX processing module 630 does not implement the DNN(s) and uses one or more conventional mechanisms to receive/process the RAR signal 150 or CR signal 1412 and generate the output. Also, the RAR signal 150 or CR signal 1412 received by the UE RAR RX processing module 630 via the RF signal 626 can be a DNN-created signal, a conventionally created signal, or a combination thereof.

In a CFRA configuration, the RAR signal 150 represents a RAR message (Msg2), and the one or more DNNs of the UE RAR RX processing module 630 process the RAR signal 150 to determine if the RACH procedure was successful or unsuccessful. In one example, the one or more DNNs determine that the RACH procedure was successful if the one or more DNNs can decode a PDCCH associated with the RAR signal 150 using the UEID of the UE 108 within a given RAR window. Otherwise, the one or more DNNs consider the RACH procedure unsuccessful. In at least some embodiments, the one or more DNNs of the UE RAR RX processing module 630 output an indication 132 that the RACH procedure was successful or an indication 134 that the RACH procedure was unsuccessful and provide this indication to another component of the UE 108, such as the RACH management module 220. This component can use these indicators 132 or 134 to determine if the UE 108 should perform additional RACH steps. For example, if the RACH management module 220 receives an indication 134 that the RACH procedure was unsuccessful, the RACH management module 220 configures the UE 108 to retry the RACH procedure. The UE then repeats the techniques described above. In at least some embodiments, when retrying the RACH procedure, the UE can select a new TX neural network architecture for the UE PRACH TX processing module 618 or use the same TX network architecture with one or both of a higher transmit power and different weights for the neural network. In at least some embodiments, if the RACH procedure was successful, the one or more DNNs of the UE RAR RX processing module 630 output information, such as a timing advance and UL resource grant, obtained from the RAR signal 150. The one or more DNNs of the UE PRACH TX processing module 618 (or a separate PUSCH TX processing module) can receive this information to generate an output representing a PUSCH signal (Msg3) including, for example, a payload for a higher protocol layer, an RRC Connection Request, and so on. The RF antenna interface 204 and one or more antennas 202 of the UE 108 convert the PUSCH signal output into a corresponding RF signal that is wirelessly transmitted on a PUSCH for reception by the BS 110. The UE 108 then enters into an RRC_Connected state.

In a four-step CBRA configuration, the one or more DNNs of the UE RAR RX processing module 630 (or a separate UE CR RX processing module) receive a CR signal 1412 instead of a RAR signal 150. The one or more DNNs process the CR signal 1412 to determine if the RACH procedure was successful or unsuccessful. In one example, the one or more DNNs determine the RACH procedure was successful if, prior to a CR timer expiring, the one or more DNNs can decode a PDCCH associated with the CR signal using the UEID of the UE 108 or determines that the UEID associated with the PDSCH is the same as the UEID associated with the PUSCH signal 612 (Msg3) transmitted by the UE 108. Otherwise, the one or more DNNs consider the RACH procedure unsuccessful. In at least some embodiments, the one or more DNNs of the UE RAR RX processing module 630 output RACH success/failure indicators 132 or 134 similar to the CFRA configuration described above. If the RACH procedure is successful, the UE 108 enters into an RRC_Connected state. If the RACH procedure was unsuccessful, the UE 108 retries the RACH procedure and repeats the techniques described above.

In a two-step CFRA/CBRA configuration, the RAR signal 150 represents a combined RAR signal 150 (Msg2) and CR signal 1412 (Msg4). This combined message can be referred to as a MsgB. The one or more DNNs of the UE RAR RX processing module 630 process the RAR signal 150 to determine if the RACH procedure was successful or unsuccessful. For example, the one or more DNNs determine the RACH procedure is unsuccessful if a RAR signal 150 associated with the UEID of the UE 108 is not received by the UE 108 within a given window. Otherwise, the one or more DNNs determine the RACH procedure was successful. In at least some embodiments, the one or more DNNs of the UE RAR RX processing module 630 output RACH success/failure indicators 132 or 134 similar to the CFRA configuration described above. If the RACH procedure was unsuccessful, the UE 108 retries the RACH procedure and repeats the techniques described above.

If the RACH procedure was successful, the one or more DNNs of the UE RAR RX processing module 630 further process the RAR signal 150 to determine if the RAR signal 150 includes a fallbackRAR indicator or a successRAR indicator. The fallbackRAR indicator can be associated with the preamble ID of the PRACH signal 610 transmitted by the UE 108 and can include a UL grant for retransmission of the PUSCH signal 612 portion of the RACH signal 124 (MsgA) by the UE 108, a time-advance command, and so on. The successRAR indicator can indicate a contention resolution ID of the UE 108 (e.g., the UEID), the C-RNTI of the UE 108. or a time-advance command to the UE 108. If the RAR signal 150 includes a successRAR indicator associated with the UEID of the UE 108, this indicates that the BS 110 detected the preamble associated with the PRACH signal 610 portion of the RACH signal 124 and successfully decoded the PUSCH signal 612 portion of the RACH signal 124. As such, the UE 108 enters into an RRC_Connected state. However, if RAR signal 150 includes a fallbackRAR indicator, this indicates the BS 110 detected the preamble associated with the PRACH signal 610 portion of the RACH signal 124 transmitted by the UE 108 but was unable to successfully decode the PUSCH signal 612 portion. As such, the one or more DNNs generate an output including, for example, information from the fallback indicator. This information can be included in or separate from the RACH success indicator 132 or RACH failure indicator 134. The RACH management module 220, a DNN, or another component of the UE 108 can use the output generated by the one or more DNNs of the UE RAR RX processing module 630 to configure the UE PRACH TX processing module 618 for retransmitting the PUSCH payload. In some implementations, the UE can use a different TX neural network to generate the PUSCH payload than the TX neural network used to generate the output for MsgA.

Accordingly, the one or more DNNs of the UE PRACH TX processing module 618, the BS PRACH RX processing module 638, the BS RAR TX processing module 646, and the UE RAR RX processing module 630 provide processing that, in effect, results in their respective processing of received signals or generation of output signals, with such processing being trained into the one or more DNNs via individual or joint training rather than requiring laborious and inefficient hardcoding of algorithms or separate discrete processing blocks to the same process.

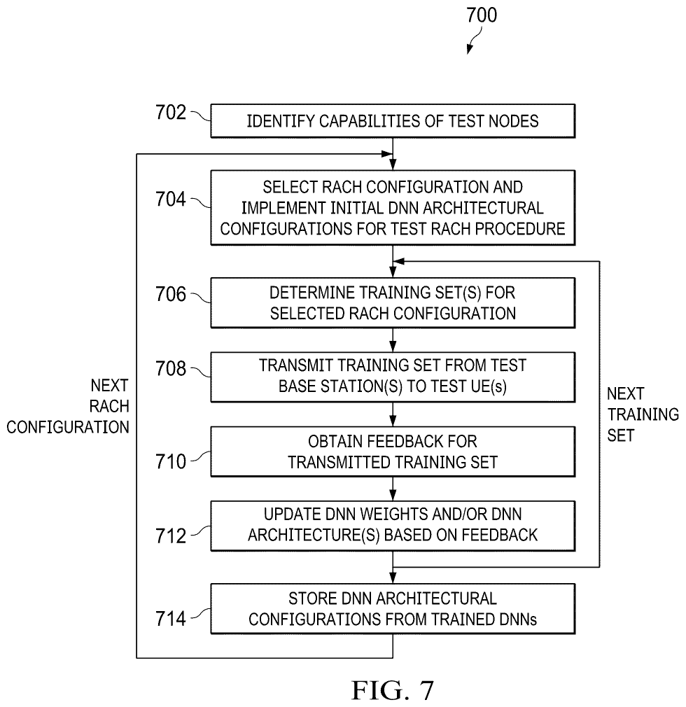

DNNs or other neural networks for implementing a RACH path between a UE 108 and a BS 110 provide flexibility in design and facilitate efficient updates relative to conventional per-block design and test approaches while also allowing the devices in the RACH path to quickly adapt their generation, transmission, and processing of RACH-related signals based on current operational parameters and capabilities. However, before the DNNs can be deployed and put into operation, they typically are trained or otherwise configured to provide suitable outputs for a given set of one or more inputs. To this end, FIG. 7 illustrates an example method 700 for developing one or more jointly trained DNN architectural configurations as options for the devices in a RACH path for different operating environments or capabilities in accordance with some embodiments. Note that the order of operations described with reference to FIG. 7 is for illustrative purposes only and that a different order of operations can be performed, and further that one or more operations can be omitted, or one or more additional operations included in the illustrated method. Further note that while FIG. 7 illustrates an offline training approach using one or more test nodes, a similar approach can be implemented for online training using one or more nodes that are in active operation. Also, in at least some embodiments, the DNNs of one or more of the UE 108 or BS 110 are individually trained compared to being jointly trained.

As explained above, the operations of DNNs employed at one or both devices in the DNN chain forming a corresponding RACH path can be based on particular capabilities and current operational parameters of the RACH path, such as the operational parameters and/or capabilities of the device employing the corresponding DNN, of one or more upstream or downstream devices, or a combination thereof. These capabilities and operational parameters can include, for example, the types of sensors used to sense a current circumstance of a device, the capabilities of such sensors, the power capacity of one or more devices, the processing capacity of the one or more devices, the RF antenna interface configurations (e.g., number of beams, antenna ports, frequencies supported) of the one or more devices, and the like. Because the described DNNs utilize such information to dictate their operations, it will be appreciated that in many instances the particular DNN configuration implemented at one of the nodes is based on particular capabilities and operational parameters currently employed at that device or at the device on the opposite side of the RACH path; that is, the particular DNN configuration implemented is reflective of capability information and operational parameters currently exhibited by the RACH path implemented by the UE and BS 110.

Accordingly, the method 700 initiates at block 702 with the identification of the anticipated capabilities (including anticipated operational parameters or parameter ranges) of one or more test nodes of a test RACH path, which would include one or more test UEs and one or more test BSs (also referred to as “test devices” for brevity). For the following, it is assumed that a training module 408 of the managing component 154 is managing the joint training, and thus the capability information for the test devices is known to the training module 408 (e.g., via a database or another locally stored data structure storing this information). However, because the managing component 154 likely does not have a priori knowledge of the capabilities of any given UE, the test UE provides the managing component 154 with an indication of its capabilities, such as an indication of the types of sensors available at the test UE, an indication of various parameters for these sensors (e.g., imaging resolution and picture data format for an imaging camera, satellite-positioning type and format for a satellite-based position sensor, etc.), accessories available at the device and applicable parameters (e.g., number of audio channels), and the like. For example, the test UE can provide this indication of capabilities as part of a UECapabilityInformation Radio Resource Control (RRC) message typically provided by UEs in response to a UECapabilityEnquiry RRC message transmitted by a BS in accordance with at least the 4G LTE and 5G NR specifications. Alternatively, the test UE can provide the indication of sensor capabilities as a separate side-channel or control-channel communication. Further, in some embodiments, the capabilities of test devices are stored in a local or remote database available to the managing component 154, and thus the managing component 154 can query this database based on some form of an identifier of the test device, such as an International Mobile Subscriber Identity (IMSI) value associated with the test device.

In at least some embodiments, the training module 408 attempts to train every RACH configuration permutation. However, in implementations in which the UEs 108 and BSs 110 are likely to have a relatively large number and variety of capabilities and other operational parameters, this effort can be impracticable. Accordingly, at block 704 the training module 408 can select a particular RACH configuration for which to jointly train the DNNs of the test devices from a specified set of candidate RACH configurations. Therefore, in at least some embodiments, each candidate RACH configuration represents a particular combination of test device RACH relevant parameters, parameter ranges, or combinations thereof. Such parameters or parameter ranges can include sensor capability parameters, processing capability parameters, battery power parameters, RF-signaling parameters, such as number and types of antennas, number and types of subchannels, etc., and the like. With a candidate RACH configuration selected for training, at block 704 the training module 408 identifies an initial DNN architectural configuration for each of the test UE and BS and directs the test devices to implement these respective initial DNN architectural configurations, either by providing an identifier associated with the initial DNN architectural configuration to the test device in instances where the test device stores copies of the candidate initial DNN architectural configurations, or by transmitting data representative of the initial DNN architectural configuration itself to the test device.

With a RACH configuration selected and the test devices initialized with DNN architectural configurations based on the selected RACH configuration, at block 706 the training module 408 identifies one or more sets of training data for use in jointly training the DNNs of the DNN chain based on the selected RACH configuration and initial DNN architectural configurations. That is, the one or more sets of training data include or represent data that could be provided as input to a corresponding DNN in an offline or online operation and thus suitable for training the DNNs. To illustrate, this training data can include a stream of test PRACH signals, test PUSCH signals, test RAR signals, test CR signals, test parameters or configurations for the test signals test. test sensor data consistent with the sensors included in the configuration under test, test received representations of PRACH signals, test received representations of PUSCH signals, test received representations of RAR signals, test received representations of CR signals, and the like.

With one or more training sets obtained, at block 708 the training module 408 initiates the joint training of the DNNs of the test RACH path. This joint training typically involves initializing the bias weights and coefficients of the various DNNs with initial values, which generally are selected pseudo-randomly, then inputting a set of training data at the TX processing module (e.g., the UE PRACH TX processing module 618) of the test UE device, wirelessly transmitting the resulting output as a transmission to the RX processing module of the test BS device (e.g., the BS PRACH RX processing module 638), analyzing the resulting output, and then updating the DNN architectural configurations based on the analysis. The joint training can further include inputting a set of training data at the TX processing module (e.g., the BS RAR TX processing module 646) of the test BS device, wirelessly transmitting the resulting output as a transmission to the RX processing module (e.g., the UE RAR RX processing module 630) of the test UE device, analyzing the resulting output, and then updating the DNN architectural configurations based on the analysis. In another example, the joint training includes end-to-end joint training including inputting a set of training data at the TX processing module (e.g., the UE PRACH TX processing module 618) of the test UE device, wirelessly transmitting the resulting output as a transmission to the RX processing module of the test BS device (e.g., the BS PRACH RX processing module 638), providing the output of the RX processing module of the test BS device as input to the TX processing module (e.g., the BS RAR TX processing module 646) of the test BS device, wirelessly transmitting the resulting output as a transmission to the RX processing module of the test BS device (e.g., the UE RAR RX processing module 630) analyzing the resulting output, and then updating the DNN architectural configurations based on the analysis. In at least some embodiments, at least one of the DNN architectural configurations of one or more of the test devices are individually trained.

As is frequently employed for DNN training, feedback obtained as a result of the actual result output of one or more of the UE PRACH TX processing module 618, the BS PRACH RX processing module 638, the BS RAR TX processing module 646, or the UE RAR RX processing module 630 is used to modify or otherwise refine parameters of one or more DNNs of the RACH path, such as through backpropagation. Accordingly, at block 710 the managing component 154 and/or the DNN chain obtain feedback for the transmitted training set. Implementation of this feedback can take any of a variety of forms or combinations of forms. In at least some embodiments, the feedback includes the training module 408 or another training module determining an error between the actual result output and the expected result output, and backpropagating this error throughout the DNNs of the DNN chain. For example, as the processing by the DNN chain effectively provides a form of Random Access, the objective feedback on the training data set can some form of measurement of the accuracy of RACH signal detection, transmission error, reception error, and the like.

At block 712, the managing component 154 or DNN chain uses the feedback obtained as a result of the transmission of the test data set through the DNN chain and presentation or other consumption of the resulting output at the test transmitting device is to update various aspects of one or more DNNs of the RACH path, such as through backpropagation of the error to change weights, connections, or layers of a corresponding DNN, or through managed modification by the managing component 154 in response to such feedback. The managing component 154 (or another network component) performs the training process of blocks 706 to 712 for the next set of training data selected at the next iteration of block 706 and repeats until a certain number of training iterations have been performed or until a certain minimum error rate has been achieved.

As a result of the joint (or individual) training of the neural networks along the RACH path between a test UE device and test BS device, each neural network has a particular neural network architectural configuration, or DNN architectural configuration in instances in which the implemented neural networks are DNNs, that characterizes the architecture and parameters of corresponding DNN, such as the number of hidden layers, the number of nodes at each layer, connections between each layer, the weights, coefficients, and other bias values implemented at each node, and the like. Accordingly, when the joint or individual training of the DNNs of the RACH path for a selected RACH configuration is complete, at block 714, the managing component 154 (or another network component) distributes some or all of the trained DNN configurations to the UE 108 and BS 110 in the system 100. Each node stores the resulting DNN configurations of their corresponding DNNs as a DNN architectural configuration. In at least one embodiment, the managing component 154 (or another network component) can generate the DNN architectural configuration by extracting the architecture and parameters of the corresponding DNN, such as the number of hidden layers, number of nodes, connections, coefficients, weights, and other bias values, and the like, at the conclusion of the joint training. In other embodiments, the managing component 154 stores copies of the paired DNN architectural configurations as candidate neural network architectural configurations 414 of the set 412. The managing component 154 (or another network component) then distributes these DNN architectural configurations to the UE 108 and BS 110 on an as-needed basis.

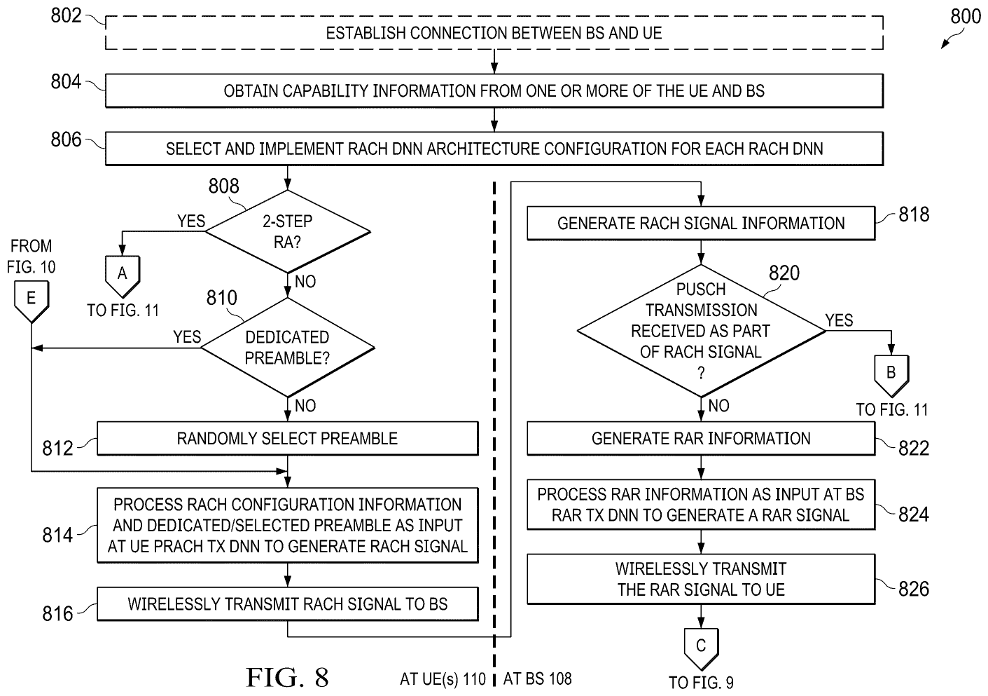

In the event that there are one or more other candidate RACH configurations remaining to be trained, then the method 700 returns to block 704 for the selection of the next candidate RACH configuration to be jointly trained, and another iteration of the subprocess of blocks 704 to 714 is repeated for the next RACH configuration selected by the training module 408. Otherwise, if the DNNs of the RACH path have been jointly trained for all intended RACH configurations, then method 700 completes and the system 100 can shift to neural-network-supported RACH procedure, as described below with reference to FIGS. 8-15.

As noted above, the managing component 154 (or another network component) can perform the joint training process using offline test nodes (that is, while no active communications of control information or user-plane data are occurring) or while the actual nodes of the intended transmission path are online (that is, while active communications of control information or user-plane data are occurring). Further, in some embodiments, rather than the managing component 154 training all of the DNNs jointly, in some instances, a subset of the DNNs can be trained or retrained while the managing component 154 maintains other DNNs as static. To illustrate, the managing component 154 detects that the DNN of a particular device is operating inefficiently or incorrectly due to, for example, capability changes in the device implementing the DNN or in response to a previously unreported loss of processing capacity, and thus the managing component 154 schedules individual retraining of the DNN(s) of the device while maintaining the other DNNs of the other devices in their present configurations.

Further, it will be appreciated that, although there can be a wide variety of devices supporting a large number of RACH configurations, many different nodes can support the same or similar RACH configuration. Thus, rather than have to repeat the joint training for every device that is incorporated into the RACH path, following joint training of a representative device, that device can transmit a representation of its trained DNN architectural configuration for a RACH configuration to the managing component 154, and the managing component 154 can store the DNN architectural configuration and subsequently transmit it to other devices that support the same or similar RACH configuration for implementation in the DNNs of the RACH path.

Moreover, the DNN architectural configurations often will change over time as the corresponding devices operate using the DNNs. Thus, as operation progresses, the neural network management module of a given device (e.g., neural network management modules 216, 314) can be configured to transmit a representation of the updated architectural configurations of one or more of the DNNs employed at that node, such as by providing the updated gradients and related information, to the managing component 154 in response to a trigger. This trigger can be the expiration of a periodic timer, a query from the managing component 154, a determination that the magnitude of the changes has exceeded a specified threshold, and the like. The managing component 154 then incorporates these received DNN updates into the corresponding DNN architectural configuration and, thus, has an updated DNN architectural configuration available for distribution to the nodes in the transmission path as appropriate.

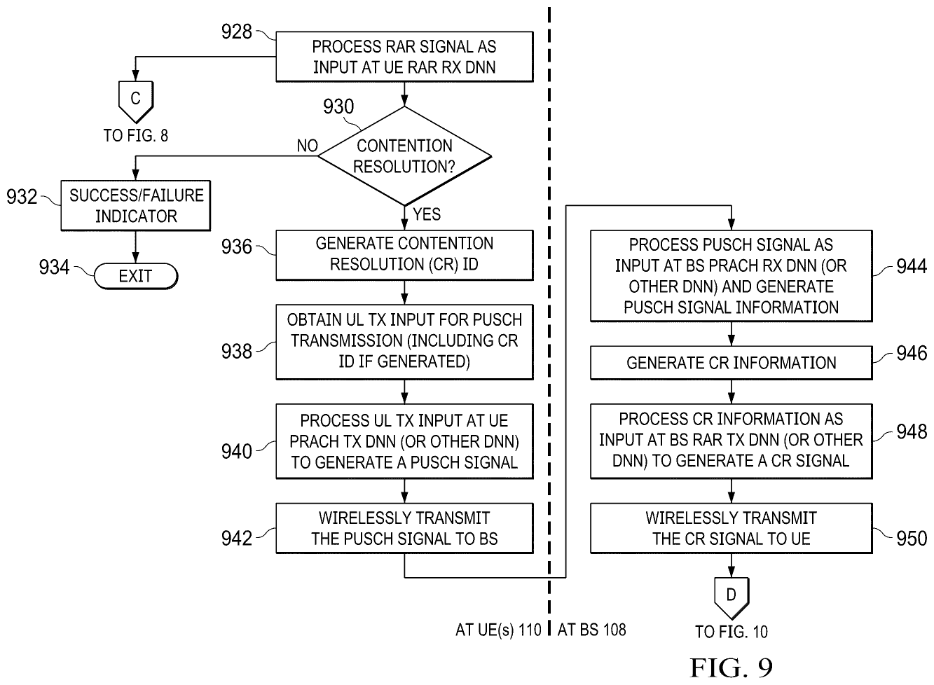

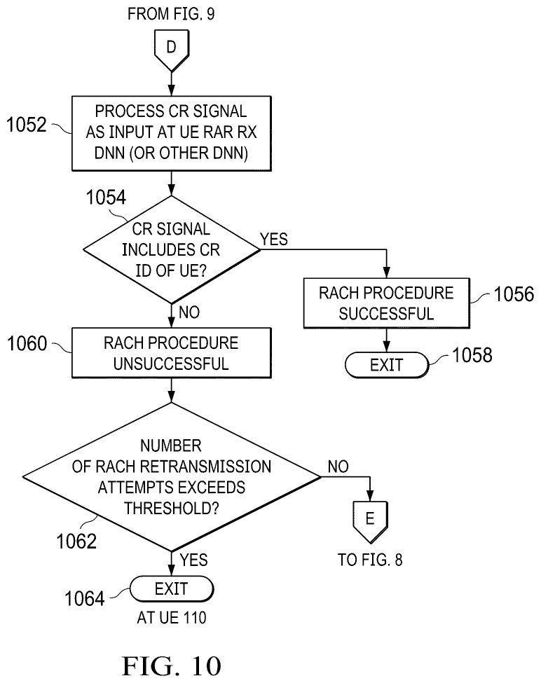

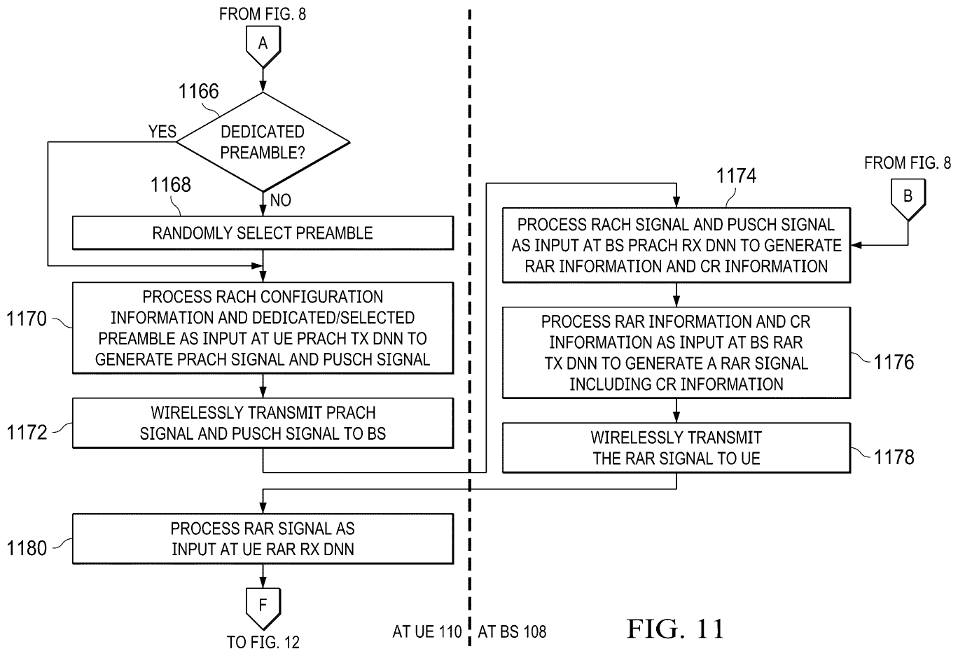

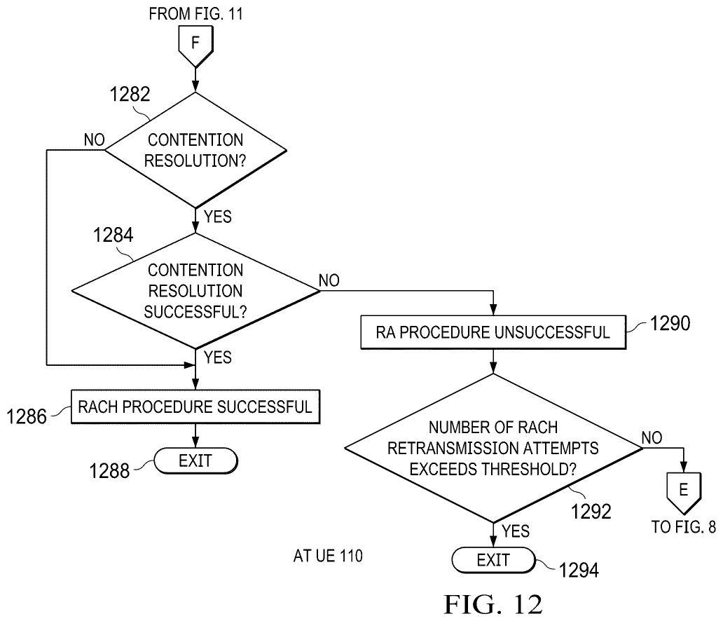

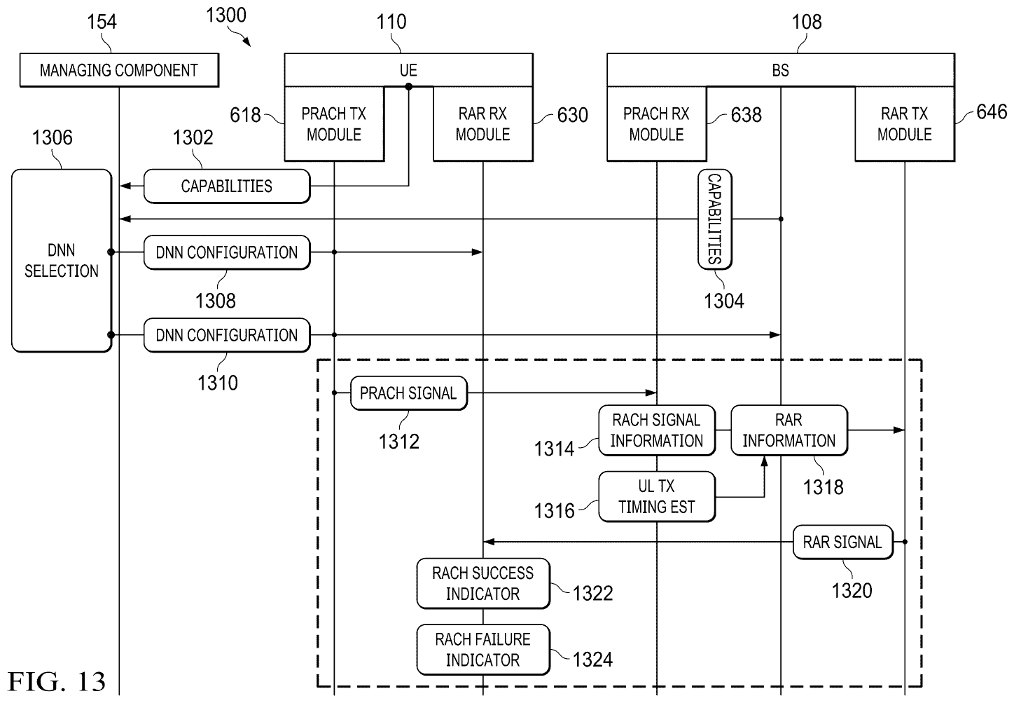

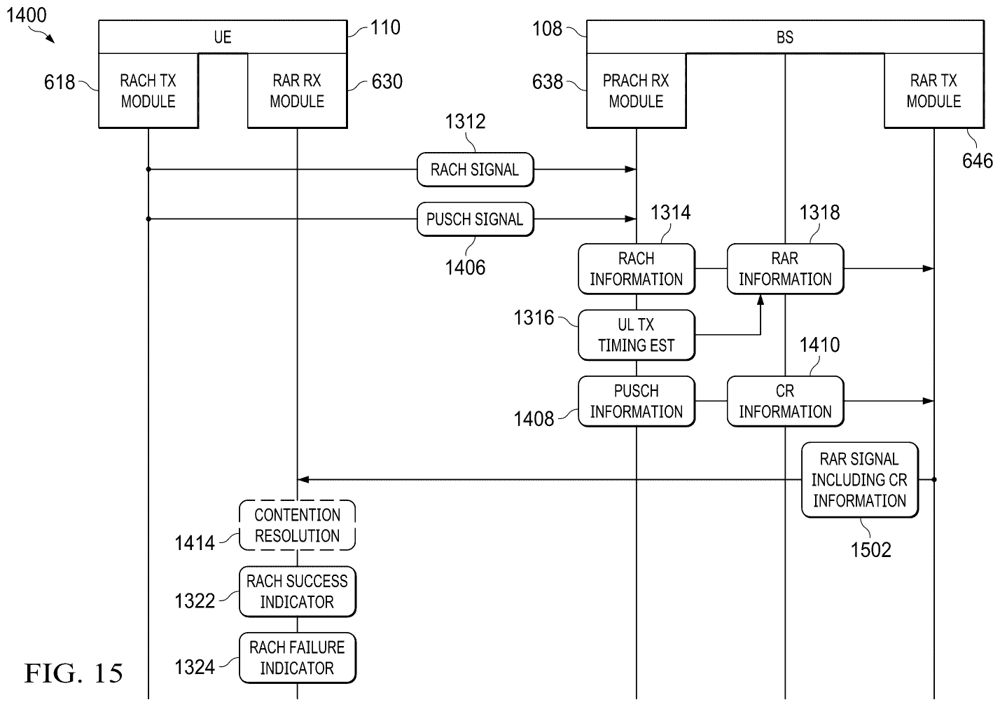

FIGS. 8 to 14 together illustrate an example method 800 for performing different types of RACH procedures using a trained DNN-based RACH path between wireless devices in accordance with some embodiments. For ease of discussion, the method 800 of FIG. 8 is described below in the example context of the RACH path 114 of FIGS. 1 and 6 and details previously described above are not repeated for purposes of brevity. Further, the processes of method 800 are described with reference to the example transaction (ladder) diagrams 1300 to 1500 of FIG. 13 to FIG. 15. In particular, the transaction (ladder) diagram 1300 of FIG. 13 corresponds to the operations described with respect to FIG. 8 and FIG. 9. The transaction (ladder) diagram 1400 of FIG. 14 corresponds to the operations described with respect to FIG. 9 and FIG. 10. The transaction (ladder) diagram 1500 of FIG. 15 corresponds to the operations described with respect to FIG. 11 and FIG. 12. Also, although FIG. 8 to FIG. 12 illustrate method 800 as one continuous flow, separate flows for each different type of RACH configuration (e.g., CFRA, four-step CBRA, and two-step CFRA/CBRA) are applicable as well.

In some embodiments, method 800 initiates at block 802 with the UE 108 and BS 110 establishing a wireless connection, such as via a 5G NR stand-alone registration/attach process in a cellular context or via an IEEE 802.11 association process in a wireless local area network (WLAN) context. In other embodiments, such as when the UE 108 moves into the BS cell while in idle mode, the method 800 initiates at block 804. For other RACH-related events (e.g., handover, secondary cell addition or change, etc.), the method can be initiated at block 804 or a later block, such as block 806 or block 808. At block 804, the managing component 154 obtains capability information from one or more of the UE 108 and the BS 110, such as capability information 1302 (FIG. 13) provided by the capabilities management module 218 (FIG. 2) of the UE 108 and the capability information 1304 (FIG. 13) provided by the capabilities management module 318 (FIG. 3) of the BS 110. In at least some embodiments, the managing component 154 is already informed of the capabilities of the BS 110 when it is part of the same infrastructure network, in which case obtaining the capability information 1304 for the BS 110 can include accessing a local or remote database or other data store for this information. In at least some embodiments, the BS 110 can send a capabilities request to the UE 108. The UE 108 responds to this request with the capability information 1302, which the BS 110 then forwards to the managing component 154. For example, the BS 110 can send a UECapabilityEnquiry RRC message, which the UE 108 responds to with a UECapabilityInformation RRC message that contains the RACH-relevant capability information.

At block 806, the neural network selection module 410 of the managing component 154 uses, for example, the capability information and other information representative of the RACH configuration between the UE 108 and the BS 110 to select an individual or a pair of RACH DNN architectural configurations to be implemented individually or jointly at the UE 108 and the BS 110 for supporting the RACH path 114 (DNN selection 1306, FIG. 13). In at least some embodiments, the neural network selection module 410 employs an algorithmic selection process in which the capability information obtained from the UE 108 and the BS 110 and the RACH configuration parameters of the RACH path 114 are compared to the attributes of pairs of candidate neural network architectural configurations 414 in the set 412 to identify a suitable pair of DNN architectural configurations. In other embodiments, the neural network selection module 410 organizes the candidate DNN architectural configurations in one or more LUTs, with each entry storing a corresponding pair of DNN architectural configurations and being indexed by a corresponding combination of input parameters or parameter ranges and, thus, the neural network selection module 410 selects a suitable pair of DNN architectural configurations to be employed by one or both of the UE 108 and the BS 110 via the provision of the capabilities and RACH configuration parameters identified at block 804 as inputs to the one or more LUTs. In at least some embodiments, the managing component 154 obtains updated capability information from the UE 108 and the BS 110. The managing component 154 can then select different DNN architectures for one or more of the UE 108 and the BS 110 based on the updated capability information. Also, a DNN architecture selected by the managing component 154 for the UE 108 can correspond to a DNN architecture selected for the BS 110. For example, a UE PRACH TX DNN architecture can correspond with a BS PRACH RX architecture such that the BS PRACH RX architecture is configured to process the RACH signal 124 generated by the UE PRACH TX DNN.

Further at block 806, the managing component 154 directs one or both of the UE 108 and the BS 110 to implement their respective DNN architectural configuration from the selected individually or jointly trained DNN architectural configurations. In implementations in which each of the UE 108 and the BS 110 stores candidate DNN architectural configurations for potential future use, the managing component 154 can transmit a message with an identifier of the DNN architectural configuration to be implemented by the UE 108 and the BS 110. Otherwise, the managing component 154 can transmit information representative of the DNN architectural configuration as, for example, a Layer 1 signal, a Layer 2 control element, a Layer 3 RRC message, or a combination thereof. For example, with reference to FIG. 13, the managing component 154 sends to the UE 108 a DNN configuration message 1308 that includes data representative of the DNN architectural configuration selected for the UE 108. In response to receiving this message, the neural network management module 216 of the UE 108 extracts the data from the DNN configuration message 1308 and configures one or more of the UE PRACH TX processing module 618 or the UE RAR RX processing module 630 to implement one or more DNNs having the DNN architectural configuration represented in the extracted data. Similarly, the managing component 154 sends to the BS 110 a DNN configuration message 1310 that contains data representative of the DNN architectural configuration selected for the BS 110. In response to receiving this message, the neural network management module 314 of the BS 110 extracts the data from the DNN configuration message 1310 and configures one or more of the BS PRACH RX processing module 638 or the BS RAR TX processing module 646 to implement one or more DNNs having the DNN architectural configuration represented in the extracted data.

With the DNNs of the RACH path 114 being initially configured, the RACH process can begin. At block 808, based on the selected RACH configurations or RACH configuration information 120 provided by the BS 110, the UE 108 determines if 2-step RACH is to be performed by the UE 108. If the UE 108 is to perform two-step RACH, the process continues to block 1166 of FIG. 11. Otherwise, the UE 108 performs a CFRA or a four-step CBRA procedure, and the process continues to block 810. At block 810, a component of the UE 108, such as the UE RACH management module 220, determines if RACH configuration information 120 provided by the BS 110 identifies a dedicated RACH preamble (CFRA). If so, the flow continues to block 814. Otherwise, the UE 108 selects a random RACH preamble (four-step CBRA) from a set of available contention-based RACH preambles identified in the RACH configuration information 120. In another example, the UE PRACH TX DNN 118 can detect a dedicated RACH preamble or select a RACH preamble based on the RACH configuration information 120. At block 814, the UE PRACH TX DNN 118 receives and processes input, such as the RACH configuration information 120, the dedicated/selected preamble, sensor information, and the like, to generate a RACH signal 124. For example, the UE PRACH TX DNN 118 generates an output representing a PRACH signal 1312 (FIG. 13) or a PUSCH signal 1406 (FIG. 14) in addition to the PRACH signal 1312. At block 816, the RF front end 126 of the UE 108 modulates an analog signal representing the RACH signal 124 with the appropriate carrier frequency and transmission power for RF transmission 148 of the RACH signal 124 to the BS 110.

The RF front end 140 of the BS 110 receives and provides the RACH signal 124 as an input to the BS PRACH RX DNN 138. At block 818, the BS PRACH RX DNN 138 processes the RACH signal 124 to generate RACH signal information 1314 (FIG. 13). The BS PRACH RX DNN 138, in at least some embodiments, also generates a UL TX timing estimate 1316 (FIG. 13). At block 820, the BS PRACH RX DNN 138 (or another component of the BS 110) determines the type of RACH signal (e.g., Msg1 or MsgA) received from the UE 108 based on, for example, the RACH signal information 1314. If the BS PRACH RX DNN 138 determines that a MsgA (PUSCH signal 1406 in combination with a PRACH signal 1312) was received, the flow continues to block 1174 of FIG. 11. Otherwise, at block 822, the RACH management module 142 of the BS 110 receives the RACH signal information 1314 and the UL TX timing estimate 1316 as input and generates RAR information 1318 (FIG. 13). In at least some embodiments, the BS PRACH RX DNN generates RAR information 1318 instead of the RACH management module 142.

At block 824, the BS RAR TX DNN 146 receives the RAR information 1318 as input and generates an output representing a RAR signal 1320 (FIG. 13). At block 826, the RF front end 140 of the BS 110 modulates an analog signal representing the RAR signal 1320 with the appropriate carrier frequency and transmission power for RF transmission of the RAR signal 1320 to the UE 108. The RF front end 126 of the UE 108 receives and provides the RAR signal 1320 as an input to the UE RAR RX DNN 130. At block 928 (FIG. 9), the UE RAR RX DNN 130 processes the RAR signal 1320. At block 930, the UE RAR RX DNN 130 determines if contention resolution is to be performed based on the processed RAR signal 1320. At block 932, the UE RAR RX DNN 130 determines that contention resolution is not required if the UE 108 is performing CFRA and outputs a RACH SUCCESS indicator 1322 or a RACH FAILURE indicator 1324. The process then ends at block 934. Alternatively, if the RACH process is unsuccessful, the flow can return to block 814, and the UE 108 can retransmit the RACH signal 124 using a different UE PRACH TX DNN, a different TX power, or the like.

Returning to block 930, the UE RAR RX DNN 130 (or another component of the UE 108) determines that contention resolution is required if the UE 108 is performing four-step CBRA. As such, the UE RAR RX DNN 130 (or another component of the UE 108) generates a CR ID 1402 (FIG. 14) for the UE 108, such as a random number, at block 936. At block 938, the UE PRACH TX DNN 118 (or a PUSCH TX portion of PRACH TX DNN 118) obtains UL TX input 1404 (FIG. 14), such as payload/data 614, a PUSCH assignment, the UE CR ID, and the like, for a PUSCH transmission. At block 940, the PRACH TX DNN 118 (or another DNN) processes the UL TX input 1404 to generate an output representing a PUSCH signal 1406 (FIG. 14). At block 942, the RF front end 126 of the UE 108 modulates an analog signal representing the PUSCH signal 1406 with the appropriate carrier frequency and transmission power for RF transmission of the PUSCH signal 1406 to the BS 110.

The RF front end 140 of the BS 110 receives and provides the PUSCH signal 1406 as an input to the BS PRACH RX DNN 138 (or a PUSCH RX portion of PRACH RX DNN 138). At block 944, the BS PRACH RX DNN 138 (or another DNN) processes the PUSCH signal 1406 to generate PUSCH signal information 1408 (FIG. 14). At block 946, the RACH management module 142 of the BS 110 receives the PUSCH signal information 1408 as input and generates CR information 1410 (FIG. 14). At block 948, the BS RAR TX DNN 146 (or a PUSCH TX portion of the BS RAR TX DNN 146) receives the PUSCH signal information 1408 as input and generates an output representing a CR signal 1412. At block 950, the RF front end 140 of the BS 110 modulates an analog signal representing the CR signal 1412 with the appropriate carrier frequency and transmission power for RF transmission of the CR signal 1412 to the UE 108.

The RF front end 126 of the UE 108 receives and provides the RAR signal 1320 as an input to the UE RAR RX DNN 130 (or a CR portion of the UE RAR RX DNN 130). At block 1052 (FIG. 10), the UE RAR RX DNN 130 (or another DNN) processes the CR signal 1412 and performs contention resolution operations 1414 (FIG. 14) at block 1154. For example, the UE RAR RX DNN 130 (or another DNN) determines if the CR signal 1412 is associated with the CR ID of the UE 108. If so, the UE RAR RX DNN 130 (or another DNN) determines that the RACH procedure was successful and outputs the RACH SUCCESS indicator 1322 at block 1156. The process then ends at block 1158. Otherwise, at block 1160, the UE RAR RX DNN 130 (or another DNN) determines that RACH procedure failed and outputs the RACH FAILURE indicator 1324. At block 1162, in response to the RACH procedure failing, one of the UE RACH DNNs or the UE RACH management module 220 determines if the number of RACH retransmission attempts exceeds a retransmission threshold. If the number of retransmission attempts has not exceeded the retransmission threshold, the flow returns to block 814, and the UE 108 can retransmit the RACH signal 124 using a different preamble, UE PRACH TX DNN, a different TX power, a combination thereof, or the like. Otherwise, the process ends at block 1164.

As described above with respect to block 808 of FIG. 8, if a two-step RACH procedure is to be performed by the UE 108, the process flows to block 1166 of FIG. 11. At block 1166, the UE RACH management module 220 (or the UE PRACH TX DNN 118) determines if the RACH configuration information 120 provided by the BS 110 identifies a dedicated RACH preamble (CFRA). If so, the flow continues to block 1170. Otherwise, at block 1168, the UE RACH management module 220 (or the UE PRACH TX DNN 118) selects a random preamble (CBRA) from a set of available contention-based preambles identified in the RACH configuration information 120. At block 1170, the UE PRACH TX DNN 118 receives and processes input, such as the RACH configuration information 120, PUSCH data 614, the dedicated/selected preamble, sensor information, a combination thereof, or the like, to generate a RACH signal 124 as described above with respect to FIG. 1 and FIG. 6. For example, the UE PRACH TX DNN 118 generates a RACH signal 124 output representing a combination of a PRACH signal 1312 and a PUSCH signal 1406. At block 1172, the RF front end 126 of the UE 108 modulates an analog signal(s) representing the PRACH signal 1312 and the PUSCH signal 1406 with the appropriate carrier frequency and transmission power for RF transmission of the PRACH signal 1312 and the PUSCH signal 1406 to the BS 110.

The RF front end 140 of the BS 110 receives and provides the PRACH signal 1312 and the PUSCH signal 1406 as input to the BS PRACH RX DNN 138. At block 1174, the BS PRACH RX DNN 138 processes the PRACH signal 1312 and the PUSCH signal 1406 to generate RACH signal information 1314 and PUSCH signal information 1408. The BS PRACH RX DNN 138, in at least some embodiments, also generates a UL TX timing estimate 1316. The BS RACH management module 142 receives the RACH signal information 1314 and the UL TX timing estimate 1316 as input and generates RAR information 1318. The BS RACH management module 142 also receives the PUSCH signal information 1408 as input and generates CR information 1410. In at least some embodiments, the BS PRACH RX DNN 138 generates RAR information 1318 and CR information 1410 instead of the RACH management module 142. At block 1176, the BS RAR TX DNN 146 receives the RAR information 1318 and the CR information 1410 as input and generates an output representing a RAR signal 1502 (FIG. 15), including RAR information 1318 and CR information 1410. At block 1178, the RF front end 140 of the BS 110 modulates an analog signal representing the RAR signal 1502 with the appropriate carrier frequency and transmission power for RF transmission of the RAR signal 1502 to the UE 108.

The RF front end 126 of the UE 108 receives and provides the RAR signal 1502 as an input to the UE RAR RX DNN 130. At block 1180, the UE RAR RX DNN 130 processes the RAR signal 1502 as input and the process continues to block 1282 of FIG. 12. At block 1282, based on processing the RAR signal 1502, the UE RAR RX DNN determines if contention resolution should be performed by the UE 108 and BS 110. If the UE RAR RX DNN determines that contention resolution is not required, the UE RAR RX DNN proceeds to output a RACH SUCCESS indicator 1322 at block 1286. The process then ends at block 1288. Otherwise, at block 1284, the UE RAR RX DNN performs contention resolution and determines if the contention resolution was successful. If contention resolution was successful, the RAR RX DNN proceeds to output a RACH SUCCESS indicator 1322 at block 1286. The process then ends at block 1288. Otherwise, the RAR RX DNN proceeds to output a RACH FAILURE indicator 1324 at block 1290. At block 1292, in response to the RACH procedure failing, one of the UE RACH DNNs or the UE RACH management module 220 determines if the number of RACH retransmission attempts exceeds a retransmission threshold. If the number of retransmission attempts has not exceeded the retransmission threshold, the flow returns to block 814 of FIG. 8, and the UE 108 retransmits the RACH signal 124 using a different preamble, UE PRACH TX DNN, a different TX power, a combination thereof, or the like. Otherwise, the process ends at block 1294.

In at least some embodiments, certain aspects of the techniques described above can be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium can be in source code, assembly language code, object code, or another instruction format that is interpreted or otherwise executable by one or more processors.

A computer-readable storage medium can include any storage medium, or combination of storage media, accessible by a computer system during use to provide instructions and/or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium can be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device can not be required, and that one or more further activities can be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims. Moreover, the particular embodiments disclosed above are illustrative only, as the disclosed subject matter can be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above can be altered or modified and all such variations are considered within the scope of the disclosed subject matter. Accordingly, the protection sought herein is as set forth in the claims below.

1. A computer-implemented method, in a user equipment (UE) of a cellular communication system, comprising:
receiving Random Access (RA) configuration information at the UE, the RA configuration information indicating:
one or more transmit neural network configurations for selection by the UE,
time resources for transmitting one or more radio frequency (RF) signals, and
frequency resources for transmitting the one or more RF signals;
configuring the transmit neural network based on the RA configuration information;
receiving at least one of a speed estimate of the UE or a doppler estimate of the UE as an input to the transmit neural network;
generating, by the transmit neural network and based on the at least one of the speed estimate of the UE or the doppler estimate of the UE, a first output, the first output representing a first RA signal for an RA procedure between the UE and a base station (BS) of the cellular communication system; and
controlling an RF antenna interface of the UE to transmit a first RF signal representative of the first output for receipt by the BS.

2. The method of claim 1, wherein generating the first output is based on receiving input at the transmit neural network including at least one of:
sensor data associated with one or more sensors of the UE; or
payload data for a physical uplink shared channel (PUSCH) transmission.

3. The method of claim 1, further comprising:
responsive to transmitting the first RF signal, receiving an input representing one or more RF signals comprising RA Response information transmitted by the BS.

4. The method of claim 3, further comprising:
generating a second output representing an indication that the RA procedure has one of succeeded or failed based on the input.

5. The method of claim 4, wherein receiving the input representing the one or more RF signals comprises receiving, at a receive neural network of the UE, the input representing the one or more RF signals.

6. The method of claim 5, further comprising:
receiving, during a handover event, an indication from the BS to implement a specific neural network architecture for at least one of the transmit neural network or the receive neural network.

7. The method of claim 5, wherein generating the second output comprises:
generating the second output at the receive neural network based on a neural network architectural configuration selected for the receive neural network from one of the one or more neural network architectural configurations.

8. The method of claim 4, further comprising:
responsive to the second output representing the indication that the RA procedure has failed, selecting a different transmit neural network for the RA procedure.

9. The method of claim 1, further comprising:
selecting, based on one or more capabilities of at least one of the UE or the BS, a neural network architectural configuration from the one or more neural network architectural configurations for the transmit neural network.

10. The method of claim 9, further comprising:
responsive to a change in the one or more capabilities of at least one of the UE or the BS, changing the neural network architectural configuration for at least the transmit neural network.

11. The method of claim 5, further comprising:
participating in joint training of the transmit neural network and the receive neural network of the UE with a receive neural network and a transmit neural network of the BS.

12. The method of claim 5, wherein generating the second output representing the indication that the RA procedure has one of succeeded or failed comprises:
determining if the input received at the receive neural network includes a Contention Resolution identifier transmitted to the BS within the first output or another output of the UE;
responsive to the input received at the receive neural network not including the Contention Resolution identifier, generating the second output representing the indication that the RA procedure has failed; and
responsive to the input received at the receive neural network including the Contention Resolution identifier, generating the second output representing the indication that the RA procedure has succeeded.

13. The method of claim 5, wherein generating the second output representing the indication that the RA procedure has one of succeeded or failed comprises:
receiving, at the receive neural network of the UE, an input representing one or more RF signals comprising RA Contention Resolution information associated with the BS; and
generating the second output representing the indication that the RA procedure has one of succeeded or failed based on the RA Contention Resolution information.

14. A computer-implemented method, in a base station (BS) of a cellular communication system, comprising:
receiving at least one parameter including:
one or more of capability parameters of a user equipment (UE) of the cellular communication system to configure a receive neural network at the UE;
configuring a transmit neural network of the BS based on the at least one parameter;
responsive to receiving Random Access (RA) Response information as input to the transmit neural network, generating, by the transmit neural network of the BS, a first output representing an RA Response signal comprising an RA Response for an RA procedure between the BS and the UE; and
controlling a radio frequency (RF) antenna interface of the BS to transmit a first RF signal representative of the RA Response signal for receipt by the UE.

15. The method of claim 14, further comprising:
receiving, at the RF antenna interface prior to generating the first output, a second RF signal from the UE, the second RF signal representative of an RA signal for the RA procedure, wherein the first output is generated based on the second RF signal received from the UE.

16. The method of claim 15, further comprising:
providing a representation of the second RF signal as a first input to a receive neural network of the BS;
generating, by the receive neural network, a second output based on the first input to the receive neural network;
generating RA Response information based on the second output; and
providing the RA Response information as a second input to the transmit neural network of the BS, wherein the transmit neural network generates the RA Response signal based on the second input.

17. The method of claim 16, further comprising:
generating Contention Resolution information based on the second output; and
providing the Contention Resolution information as a third input to the transmit neural network of the BS, wherein the transmit neural network generates the RA Response signal based on the third input.

18. A computer-implemented method comprising:
receiving capability information from at least one of a first device or a second device in a cellular communication system;
selecting a first neural network architectural configuration from a set of candidate neural network architectural configurations based on the capability information, the first neural network architectural configuration being trained to implement a Random Access procedure between the first device and the second device; and
transmitting to the first device a first indication of the first neural network architectural configuration for implementation at one or more of a transmit neural network and a receive neural network of the first device.

19. A device comprising:
a radio frequency (RF) antenna interface;
at least one processor coupled to the RF antenna interface; and
a memory storing executable instructions, the executable instructions configured to manipulate the at least one processor to perform the method of claim 1.

20. The device of claim 19, wherein the executable instructions configured to manipulate the at least one processor to generate the first output comprise instructions configured to manipulate the at least one processor to generate the first output based on receiving input at the transmit neural network including at least one of:
sensor data associated with one or more sensors of the UE; or
payload data for a physical uplink shared channel (PUSCH) transmission.
